(19) United States
(12) Patent Application Publication
(10) Pub. No.: US 2025/0008469 A1
(43) Pub. Date: Jan. 2, 2025

(54) SYSTEMS AND METHODS FOR CONFIGURED TIME WINDOW ERROR REPORTING

(71) Applicant: QUALCOMM Incorporated, San Diego, CA (US)

(72) Inventors: Alexandros MANOLAKOS, Athens, Attikí (GR); Mukesh KUMAR, Hyderabad, Punjab (IN); Srinivas YERRAMALLI, San Diego, CA (US)

(21) Appl. No.: 18/690,976

(22) PCT Filed: Oct. 12, 2022
(86) PCT No.: PCT/US2022/077982

§ 371 Date: Mar. 11, 2024

(30) Foreign Application Priority Data
Nov. 12, 2021 (GR) 20210100792

(51) Int. Cl. H04W 64/00; H04L 5/00; H04W 24/08

(52) U.S. Cl. CPC H04W 64/00; H04L 5/0051; H04W 24/08

(57) ABSTRACT

Positioning measurements to determine the location of a user equipment (UE) may be obtained within a configured time window, such as a measurement time window or positioning reference signal (PRS) processing window. If one or more position measurements cannot be obtained within the configured window, the measuring entity may provide an error report to the positioning entity indicating that it was unable to obtain one or more positioning measurements within the configured time window. The error message may be provided in the provide location information report. The error message may include the timing of the error within the configured time window, e.g., whether the error occurred at the beginning or end of the configured time window. The error message may further indicate the cause of the error, such as failure to receive a PRS processing window, or that the PRS had low priority relative to downlink signals or channels.

### BACKGROUND

### Field

Subject matter disclosed herein relates to location determination for a mobile device and more particularly to supporting a location session using a configured time window.

### Relevant Background

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Obtaining the location of a mobile device that is accessing a wireless (e.g. 5G) network may be useful for many applications including, for example, emergency calls, personal navigation, asset tracking, locating a friend or family member, etc. Positioning measurements for a UE may be made by one or more network nodes. For example, network nodes, such as a user equipment (UE), base station, or sidelink UEs, may measure positioning reference signal (PRS) resources for position determination of the UE. The measurement information for the PRS resources may be reported in a location information report to a location server for position determination. However, in many applications it is desirable to perform positioning measurements within a configured time window, e.g., to reduce latency. Use of a configured time window, such as a measurement time window or a processing window, latency may be reduced by permitting the specification of a precise future time at which a location of a user equipment (UE) is to be obtained. The use of a configured time window, however, may introduce additional uncertainties and other complications, which it is desirable to control.

### SUMMARY

Positioning measurements to determine the location of a user equipment (UE) may be obtained within a configured time window, such as a measurement time window or positioning reference signal (PRS) processing window. If the measuring entity fails to determine one or more position measurements within the configured window, the measuring entity may provide an error report to the positioning entity indicating that it was unable to obtain one or more positioning measurements within the configured time window. The error message may be provided in the provide location information report. The error message may include the timing of the error within the configured time window, e.g., whether the error occurred at the beginning or end of the configured time window. The error message may further indicate the cause of the error, such as failure to receive a PRS processing window, or that the PRS had low priority relative to downlink signals or channels.

In one implementation, a method at an entity for locating a UE within a configured time window, includes receiving the configured time window to obtain positioning measurements for the UE; attempting to obtain the positioning measurements for the UE based on positioning signals from one or more other entities within the configured time window, wherein the entity failed to obtain at least one positioning measurement within the configured time window; and sending an error message to a positioning entity indicating unable to obtain the at least one positioning measurement within the configured time window.

In one implementation, an entity in a wireless network configured for locating a UE within a configured time window, includes an external interface configured to communicate with other entities in the wireless network; at least one memory; and at least one processor coupled to the external interface and the at least one memory and configured to: receive the configured time window to obtain positioning measurements for the UE; attempt to obtain the positioning measurements for the UE based on positioning signals from one or more other entities within the configured time window, wherein the entity failed to obtain at least one positioning measurement within the configured time window; and send an error message to a positioning entity indicating unable to obtain the at least one positioning measurement within the configured time window.

In one implementation, an entity in a wireless network configured for locating a UE within a configured time window, includes means for receiving the configured time window to obtain positioning measurements for the UE; means for attempting to obtain the positioning measurements for the UE based on positioning signals from one or more other entities within the configured time window, wherein the entity failed to obtain at least one positioning measurement within the configured time window; and means for sending an error message to a positioning entity indicating unable to obtain the at least one positioning measurement within the configured time window.

In one implementation, a non-transitory storage medium including program code stored thereon, the program code is operable to configure at least one processor in an entity in a wireless network configured for locating a UE within a configured time window, the program code comprising instructions to: receive the configured time window to obtain positioning measurements for the UE; attempt to obtain the positioning measurements for the UE based on positioning signals from one or more other entities within the configured time window, wherein the entity failed to obtain at least one positioning measurement within the configured time window; and send an error message to a positioning entity indicating unable to obtain the at least one positioning measurement within the configured time window.

In one implementation, a method at a positioning entity for locating a UE within a configured time window, includes sending a configuration of a configured time window to at least one of the UE and a serving base station for the UE; and receiving an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

In one implementation, a positioning entity in a wireless network configured for locating a UE within a configured time window, includes an external interface configured to communicate with other entities in the wireless network; at least one memory; and at least one processor coupled to the external interface and the at least one memory and configured to: send a configuration of a configured time window to at least one of the UE and a serving base station for the UE; and receive an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

In one implementation, a positioning entity in a wireless network configured for locating a UE within a configured time window includes means for sending a configuration of a configured time window to at least one of the UE and a serving base station for the UE; and means for receiving an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

In one implementation, a non-transitory storage medium including program code stored thereon, the program code is operable to configure at least one processor in a positioning entity in a wireless network configured for locating a UE within a configured time window, the program code comprising instructions to: send a configuration of a configured time window to at least one of the UE and a serving base station for the UE; and receive an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates a wireless communication system including a Next Generation (NG) Radio Access Network.

FIG. 2 shows an extended architecture diagram of an NG-RAN node that includes a Location Server Surrogate (LSS).

FIG. 3 shows a structure of an exemplary subframe sequence with positioning reference signal (PRS) positioning occasions.

FIG. 4 a configured time window with respect to various actual measured windows.

FIG. 5 is a message flow illustrating the messaging for determining the location of the UE using a configured time window and reporting a configured time window error.

FIG. 6 shows a schematic block diagram illustrating certain exemplary features of a UE that is configured to perform positioning of a UE using a configured time window and reporting a configured time window error.

FIG. 7 shows a schematic block diagram illustrating certain exemplary features of a base station that is configured to perform positioning of a UE using a configured time window and reporting a configured time window error.

FIG. 8 shows a schematic block diagram illustrating certain exemplary features of a location server that is configured to perform positioning of a UE using a configured time window and a configured time window error report.

FIG. 9 shows a flowchart for an exemplary method for supporting locating a UE using a configured time window and reporting a configured time window error.

FIG. 10 shows a flowchart for an exemplary method for supporting locating a UE using a configured time window and a configured time window error report.

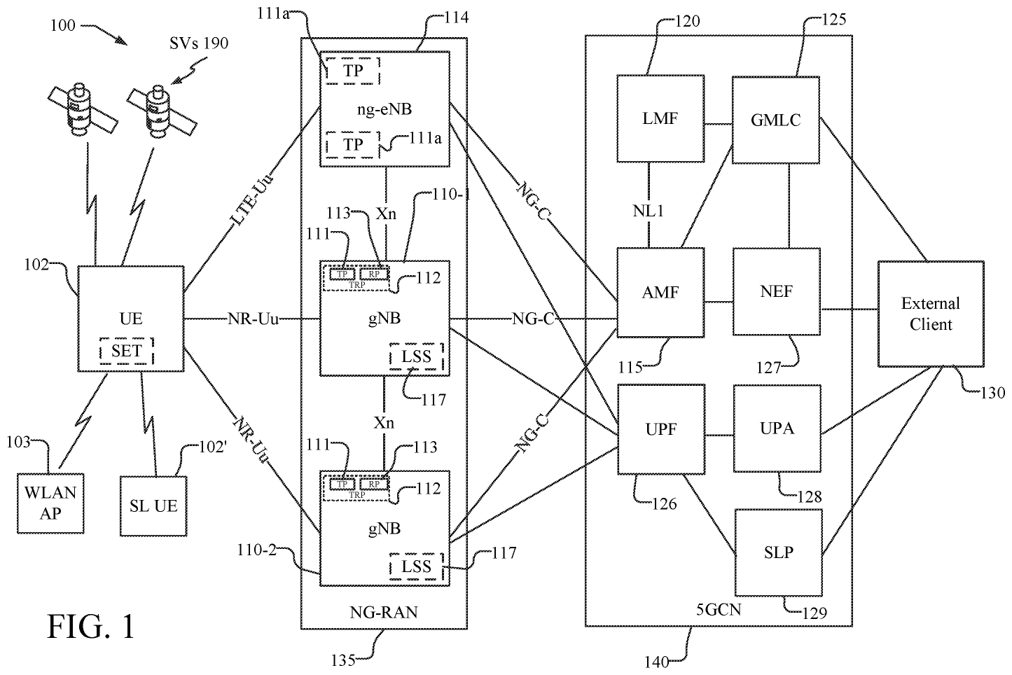

Elements, stages, steps, and/or actions with the same reference label in different drawings may correspond to one another (e.g., may be similar or identical to one another). Further, some elements in the various drawings are labelled using a numeric prefix followed by an alphabetic or numeric suffix. Elements with the same numeric prefix but different suffixes may be different instances of the same type of element. The numeric prefix without any suffix is used herein to reference any element with this numeric prefix. For example, different instances 110-1, 110-2, and 110-3 of a gNB are shown in FIG. 1. A reference to a gNB 110 may then refer to any of gNBs 110-1, 110-2, and 110-3.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “base station”, and “transmission reception point (TRP)” are not intended to be specific or otherwise limited to any particular Radio Access Technology (RAT), unless otherwise noted. In general, a UE may be any wireless communication device (e.g., a mobile phone, router, tablet computer, laptop computer, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station or transmission reception point (TRP) may operate according to one of several RATs in communication with UEs depending on the network in which it is deployed, and may be alternatively referred to as an access point (AP), a network node, a NodeB, an evolved NodeB (eNB), a New Radio (NR)Node B (also referred to as a gNB or gNodeB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel. A communication link through which UEs can send signals to other UEs is called a sidelink (SL) channel.

The term “base station” may refer to a single physical TRP or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals the UE is measuring.

To support positioning of a UE, two broad classes of location solution have been defined: control plane and user plane. With control plane (CP) location, signaling related to positioning and support of positioning may be carried over existing network (and UE) interfaces and using existing protocols dedicated to the transfer of signaling.

With user plane (UP) location, signaling related to positioning and support of positioning may be carried as part of other data using such protocols as the Internet Protocol (IP), Transmission Control Protocol (TCP) and User Datagram Protocol (UDP).

The Third Generation Partnership Project (3GPP) has defined control plane location solutions for UEs that use radio access according to Global System for Mobile communications GSM (2G), Universal Mobile Telecommunications System (UMTS) (3G), LTE (4G) and New Radio (NR) for Fifth Generation (5G). These solutions are defined in 3GPP Technical Specifications (TSs) 23.271 and 23.273 (common parts), 43.059 (GSM access), 25.305 (UMTS access), 36.305 (LTE access) and 38.305 (NR access). The Open Mobile Alliance (OMA) has similarly defined a UP location solution known as Secure User Plane Location (SUPL) which can be used to locate a UE accessing any of a number of radio interfaces that support IP packet access such as General Packet Radio Service (GPRS) with GSM, GPRS with UMTS, or IP access with LTE or NR.

Both CP and UP location solutions may employ a location server (LS) to support positioning. The location server may be part of or accessible from a serving network or a home network for a UE or may simply be accessible over the Internet or over a local Intranet. If positioning of a UE is needed, a location server may instigate a session (e.g. a location session or a SUPL session) with the UE and coordinate location measurements by the UE and determination of an estimated location of the UE. During a location session, a location server may request positioning capabilities of the UE (or the UE may provide them to the location server without a request), may provide assistance data to the UE (e.g. if requested by the UE or in the absence of a request) and may request a location estimate or location measurements from a UE, e.g. for the Global Navigation Satellite System (GNSS), Time Difference Of Arrival (TDOA), Angle of Departure (AOD), Round-Trip Time (RTT) and multi cell RTT (Multi-RTT), and/or Enhanced Cell ID (ECID) position methods. Assistance data may be used by a UE to acquire and measure GNSS and/or reference signals, such as positioning reference signals (PRS) signals (e.g. by providing expected characteristics of these signals such as frequency, expected time of arrival, signal coding, signal Doppler).

In a UE based mode of operation, assistance data may also or instead be used by a UE to help determine a location estimate from the resulting location measurements (e.g., if the assistance data provides satellite ephemeris data in the case of GNSS positioning or base station locations and other base station characteristics such as PRS timing in the case of terrestrial positioning using, e.g., TDOA, AOD, Multi-RTT, etc.).

In a UE assisted mode of operation, a UE may return location measurements to a location server which may determine an estimated location of the UE based on these measurements and possibly based also on other known or configured data (e.g. satellite ephemeris data for GNSS location or base station characteristics including base station locations and possibly PRS timing in the case of terrestrial positioning using, e.g., TDOA, AOD, Multi-RTT, etc.).

Conventionally, positioning measurements are reported to the positioning entity, e.g., the location server or the UE, in a provide location information (PLI) message. The positioning entity may use the positioning measurements received in the PLI message from one or more entities to estimate a position for the UE. If there are errors in the positioning measurements, the reasons for the error in the positioning measurements may be provided in the PLI, and used by the positioning entity when estimating a position for the UE or re-configuring the assistance data for positioning the UE.

In some scenarios, a UE, a location services (LCS) Client or application function (AF) that is requesting the location of a target UE may know a time at which the location should be obtained. For example, with a periodic deferred Mobile Terminated Location Request (MT-LR), the location of a UE is obtained at fixed periodic intervals, and thus, the location time is known in advance. In another example, such as in a factory or warehouse with moving tools, components, packages etc., there may be a precise expectation of a specific time when a moving tool, component or package etc. will reach a specific location or will have completed a specific movement or operation. In such a scenario, it may then be useful or critical to locate the tool, component or package etc. to confirm the expectation of location at the specific time and make any further adjustments. Further, the location of UEs may sometimes be scheduled to occur at specific times in the future. For example, vehicles on a road may all be located at the same time to provide an indication of traffic congestion as well as to assist with communications and safety. Likewise, people, containers, transportation systems etc., may also be located at certain common times. In scenarios such as these, scheduling in advance may be performed by configuring a time window during which the measurements are generated. The positioning measurements, for example, may be performed during a configured time window by one or more entities in the network, including the UE, one or more base stations, or one or more sidelink UEs, or any combination thereof.

The configured time window, for example, may be a measurement time window, which allows an entity, such as the location server, to schedule a window of time during which one or more positioning measurements for the UE are to be obtained and are reported in a single measurement report. The configured time window may additionally or alternatively be a processing window, e.g., PRS processing window, which may be a window configured by a base station, during which the UE may measure positioning signals (e.g., PRS) inside the active downlink (DL) bandwidth part (BWP) with the PRS having the same numerology as the active DL BWP, thereby avoiding the need for a measurement gap (MG).

With a configured time window, the positioning measurements performed during the configured time window are reported to the positioning entity, e.g., the location server or the UE in a PLI message. If an error occurred while obtaining one or more of the positioning measurements during the configured time window, however, there is currently no way for the entity to indicate that an error occurred and the entity was not able to obtain one or more positioning measurements within the configured time window.

As discussed herein, when entity, e.g., a UE, base station, or sidelink UE, is configured with a time window for obtaining positioning measurements for a UE and fails to obtain at least one positioning measurement within the configured time window, the entity may report the error to a positioning entity indicating that it was in positioning measurements by sending an error message to a positioning entity, e.g., a sidelink UE or location server, indicating unable to obtain the at least one positioning measurement within the configured time window. The error message, for example, may be included in a PLI message. The error message may indicate that positioning measurements were attempted, but that the entity was unable to obtain positioning measurements at a start of the configured time window or until an end of the configured time window. In some implementations, the error message may indicate a start and end of the measured window during which one or more positioning measurements were obtained within the configured time window. In some implementations, the configured time window may be a measurement time window, and the error message may indicate that the entity did not receive a PRS processing window. In some implementations, the configured time window may be a PRS processing window, and the error message may indicate that in the PRS processing window, the PRS priority had lower than other downlink signals or channels.

FIG. 1 shows a positioning architecture diagram of a communication system 100 that may support configured time window error reporting for scheduling in advance in an NG-RAN. The location management functionality in the NG-RAN may be a “Location Server Surrogate (LSS)” or a “Location Management Component (LMC)” and is in one or more of the gNBs 110 in FIG. 1 or may be external to the gNBs 110 but within the NG-RAN 135.

The communication system 100 may be configured for supporting location of a user equipment (UE) 102. Here, the communication system 100 comprises a UE 102, and components of a Fifth Generation (5G) network comprising a Next Generation (NG) Radio Access Network (RAN) (NG-RAN) 135 and a 5G Core Network (5GCN) 140. A 5G network may also be referred to as a New Radio (NR) network; NG-RAN 135 may be referred to as a 5G RAN or as an NR RAN; and 5GCN 140 may be referred to as an NG Core network (NGC). The communication system 100 may further utilize information from satellite vehicles (SVs) 190 for a Global Navigation Satellite System (GNSS) like GPS, GLONASS, Galileo or Beidou or some other local or regional Satellite Positioning System (SPS) such as IRNSS, EGNOS or WAAS. Additional components of the communication system 100 are described below. The communication system 100 may include additional or alternative components.

It should be noted that FIG. 1 provides only a generalized illustration of various components, any or all of which may be utilized as appropriate, and each of which may be duplicated or omitted, as necessary. Specifically, although only one UE 102 is illustrated, it will be understood that many UEs (e.g., hundreds, thousands, millions, etc.) may utilize the communication system 100. Similarly, the communication system 100 may include a larger (or smaller) number of SVs 190, gNBs 110, next generation evolved Node Bs (ng-eNBs) 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology or for other communication technologies and protocols) may be used to configure, in response to receiving a request, an increased quantity of location-related information or resources associated with broadcast communication from wireless nodes (e.g. broadcast of assistance data), transmission of Positioning Reference Signals (PRSs) or some other location related function of the wireless nodes.

The UE 102 may comprise and/or be referred to as a device, a mobile device, a wireless device, a mobile terminal, a terminal, a mobile station (MS), a Secure User Plane Location (SUPL) Enabled Terminal (SET), or by some other name. Moreover, UE 102 may correspond to a cellphone, smartphone, laptop, tablet, PDA, tracking device, navigation device, Internet of Things (IoT) device, or some other portable or moveable device. Typically, though not necessarily, the UE 102 may support wireless communication using one or more Radio Access Technologies (RATs) such as using Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G New Radio (NR) (e.g., using the NG-RAN 135 and 5GCN 140), etc. The UE 102 may also support wireless communication using a Wireless Local Area Network (WLAN) which may connect to other networks (e.g. the Internet) using a Digital Subscriber Line (DSL) or packet cable for example. The use of one or more of these RATs may allow the UE 102 to communicate with an external client 130 (via elements of 5GCN 140 not shown in FIG. 1, or possibly via a Gateway Mobile Location Center (GMLC) 125) and/or allow the external client 130 to receive location information regarding the UE 102 (e.g., via the GMLC 125).

The UE 102 may include a single entity or may include multiple entities such as in a personal area network where a user may employ audio, video and/or data I/O devices and/or body sensors and a separate wireline or wireless modem. An estimate of a location of the UE 102 may be referred to as a location, location estimate, location fix, fix, position, position estimate or position fix, and may be geographic, thus providing location coordinates for the UE 102 (e.g., latitude and longitude) which may or may not include an altitude component (e.g., height above sea level, height above or depth below ground level, floor level or basement level). Alternatively, a location of the UE 102 may be expressed as a civic location (e.g., as a postal address or the designation of some point or small area in a building such as a particular room or floor). A location of the UE 102 may also be expressed as an area or volume (defined either geographically or in civic form) within which the UE 102 is expected to be located with some probability or confidence level (e.g., 67%, 95%, etc.) A location of the UE 102 may further be a relative location comprising, for example, a distance and direction or relative X, Y (and Z) coordinates defined relative to some origin at a known location which may be defined geographically, in civic terms, or by reference to a point, area, or volume indicated on a map, floor plan or building plan. In the description contained herein, the use of the term location may comprise any of these variants unless indicated otherwise. When computing the location of a UE, it is common to solve for local x, y, and possibly z coordinates and then, if needed, convert the local coordinates into absolute ones (e.g. for latitude, longitude and altitude above or below mean sea level).

Base stations (BSs) in the NG-RAN 135 shown in FIG. 1 comprise NR NodeBs, also referred to as gNBs, 110-1 and 110-2 (collectively and generically referred to herein as gNBs 110). Pairs of gNBs 110 in NG-RAN 135 may be connected to one another—e.g. directly as shown in FIG. 1 or indirectly via other gNBs 110. Access to the 5G network is provided to UE 102 via wireless communication between the UE 102 and one or more of the gNBs 110, which may provide wireless communications access to the 5GCN 140 on behalf of the UE 102 using 5G NR. 5G NR radio access may also be referred to as NR radio access or as 5G radio access. In FIG. 1, the serving gNB for UE 102 is assumed to be gNB 110-1, although other gNBs (e.g. gNB 110-2) may act as a serving gNB if UE 102 moves to another location or may act as a secondary gNB to provide additional throughout and bandwidth to UE 102. A Location Server Surrogate (LSS) 117 within a node in the NG-RAN 135, such as in serving gNB 110-1, may perform a location server function, as discussed herein.

Base stations (BSs) in the NG-RAN 135 shown in FIG. 1 may also or instead include a next generation evolved Node B, also referred to as an ng-eNB, 114. Ng-eNB 114 may be connected to one or more gNBs 110 in NG-RAN 135—e.g. directly or indirectly via other gNBs 110 and/or other ng-eNBs. An ng-eNB 114 may provide LTE wireless access and/or evolved LTE (eLTE) wireless access to UE 102. Some gNBs 110 (e.g. gNB 110-2) and/or ng-eNB 114 in FIG. 1 may be configured to function as positioning-only beacons, which may transmit signals (e.g. PRS signals) and/or may broadcast assistance data to assist positioning of UE 102 but may not receive signals from UE 102 or from other UEs. It is noted that while only one ng-eNB 114 is shown in FIG. 1, some embodiments may include multiple ng-eNBs 114.

A location server in FIG. 1 may correspond to, e.g., Location Management Function (LMF) 120, Secure User Plane Location (SUPL) Location Platform (SLP) 129 in the 5GCN 140, a Location Server Surrogate (LSS) 117 (or a Location Management Component (LMC)) in the NG-RAN 135, or a gNB 110. Such a location server may be capable of providing positioning assistance data to UE 102 including, for example, information regarding signals to be measured (e.g., expected signal timing, signal coding, signal frequencies, signal Doppler), locations and identities of terrestrial transmitters (e.g. gNBs) and/or signal, timing and orbital information for GNSS SVs to facilitate positioning techniques such as A-GNSS, AFLT, AOD, downlink (DL) TDOA, RTT, carrier phase positioning, and ECID. The facilitation may include improving signal acquisition and measurement accuracy by UE 102 and, in some cases, enabling UE 102 to compute its estimated location based on the location measurements. For example, a location server (e.g. LMF 120 or SLP 129) may have access to an almanac, also referred to as a base station almanac (BSA), which indicates locations and identities of cellular transceivers and/or local transceivers in a particular region or regions such as a particular venue, and may provide information descriptive of signals transmitted by a cellular base station or AP (e.g. a gNB) such as transmission power and signal timing.

A UE 102 may obtain measurements of signal strengths (e.g. received signal strength indication (RSSI)) for DL signals received from cellular transceivers and/or local transceivers and/or may obtain a signal to noise ratio (S/N), a reference signal received power (RSRP), a reference signal received quality (RSRQ), a time of arrival (TOA), an angle of arrival (AOA), an angle of departure (AOD), a receive time-transmission time difference (Rx-Tx), or a round trip signal propagation time (RTT) between UE 102 and a cellular transceiver (e.g. a gNB), or a local transceiver (e.g. a WiFi access point (AP) 103). A UE 102 may use these measurements together with assistance data (e.g. terrestrial almanac data or GNSS satellite data such as GNSS Almanac and/or GNSS Ephemeris information) received from a location server (e.g. LMF 120 or SLP 129) or broadcast by a base station (e.g. a gNB 110-1, 110-2) in NG-RAN 135 to determine a location for UE 102. The cellular transceivers and/or local transceivers may obtain similar measurements for UL signals transmitted by the UE 102. Additionally or alternatively, the UE 102 may obtain similar measurements for sidelink (SL) signals transmitted by a SL UE 102′, which may be in communication with the network in a manner similar to UE 102, and/or the SL UE 102′ may obtain similar measurements for sidelink (SL) signals transmitted by the UE 102.

As noted, while FIG. 1 depicts nodes configured to communicate according to 5G NR and LTE communication protocols for an NG-RAN 135, nodes configured to communicate according to other communication protocols may be used, such as, for example, an LTE protocol for an Evolved Universal Mobile Telecommunications System (UMTS) Terrestrial Radio Access Network (E-UTRAN) or an IEEE 802.11x protocol for a WLAN. For example, in a 4G Evolved Packet System (EPS) providing LTE wireless access to UE 102, a RAN may comprise an E-UTRAN, which may comprise base stations comprising evolved Node Bs (eNBs) supporting LTE wireless access. A core network for EPS may comprise an Evolved Packet Core (EPC). An EPS may then comprise an E-UTRAN plus EPC, where the E-UTRAN corresponds to NG-RAN 135 and the EPC corresponds to 5GC 140 in FIG. 1.

The gNBs 110 and ng-eNB 114 can communicate with an Access and Mobility Management Function (AMF) 115, which, for positioning functionality may communicates with a Location Management Function (LMF) 120. The AMF 115 may support mobility of the UE 102, including cell change and handover and may participate in supporting a signaling connection to the UE 102 and possibly data and voice bearers for the UE 102. The LMF 120 may support scheduling for positioning of the UE 102 when UE accesses the NG-RAN 135 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (ECID), angle of arrival (AOA), angle of departure (AOD), and/or other positioning procedures. The LMF 120 may also process location services requests for the UE 102, e.g., received from the AMF 115 or from the GMLC 125. The LMF 120 may be connected to AMF 115 and/or to GMLC 125. The LMF 120 may be referred to by other names such as a Location Manager (LM), Location Function (LF), commercial LMF (CLMF) or value added LMF (VLMF). In some embodiments, a node/system that implements the LMF 120 may additionally or alternatively implement other types of location-support modules, such as an Enhanced Serving Mobile Location Center (E-SMLC). It is noted that in some embodiments, at least part of the positioning functionality (including derivation of a UE 102's location) may be performed at the UE 102 (e.g., using signal measurements obtained by UE 102 for signals transmitted by wireless nodes such as gNBs 110 and ng-eNB 114, and assistance data provided to the UE 102, e.g. by LMF 120). In the case of OMA SUPL location, the location server may be a SUPL Location Platform (SLP) as opposed to the LMF 120.

The Gateway Mobile Location Center (GMLC) 125 may support a location request for the UE 102 received from an external client 130 and may forward such a location request to the AMF 115 for forwarding by the AMF 115 to the LMF 120 or may forward the location request directly to the LMF 120. A location response from the LMF 120 or an LSS 117 (e.g. containing a location estimate for the UE 102) may be returned to the GMLC 125 either directly or via the AMF 115, and the GMLC 125 may then return the location response (e.g., containing the location estimate) to the external client 130. The GMLC 125 is shown connected to both the AMF 115 and LMF 120 in FIG. 1 though only one of these connections may be supported by 5GC 140 in some implementations.

The gNB 110-1 may support positioning of the UE 102 when UE 102 accesses the NG-RAN 135. The gNB 110-1 may also process location service requests for the UE 102, e.g., received directly or indirectly from the GMLC 125. In some embodiments, a node/system that implements the gNB 110-1 may additionally or alternatively implement other types of location-support modules, such as an Enhanced Serving Mobile Location Center (E-SMLC) or a Secure User Plane Location (SUPL) Location Platform (SLP) 129. It will be noted that in some embodiments, at least part of the positioning functionality (including derivation of UE 102's location) may be performed at the UE 102 (e.g., using signal measurements for signals transmitted by wireless nodes, and assistance data provided to the UE 102).

To support services including location services from external clients 130 for Internet of Things (IoT) UEs, a Network Exposure Function (NEF) 127 may be included in 5GCN 140. The NEF 127 may support secure exposure of capabilities and events concerning 5GCN 140 and UE 102 to an external client 130 and may enable secure provision of information from external client 130 to 5GCN 140. In the context of location services, NEF 127 may function to obtain a current or last known location for a UE 102, may obtain an indication of a change in location for a UE 102, or an indication of when a UE 102 becomes available (or reachable). The NEF 127 may be connected to the GMLC 125 to support last known location, current location and/or deferred periodic and triggered location for the UE 102. If desired, the NEF 127 may include, or may be combined with, the GMLC 125 and may then obtain location information for UE 102 directly from LSS 117 or LMF 120 (e.g. may be connected to the LSS 117 or the LMF 120). NEF 127 may also be connected to AMF 115 to enable NEF 127 to obtain a location for UE 102 from the AMF 115.

The User Plane Function (UPF) 126 may support voice and data bearers for UE 102 and may enable UE 102 voice and data access to other networks such as the Internet. UPF 126 functions may include: external PDU session point of interconnect to a Data Network, packet (e.g. Internet Protocol (IP)) routing and forwarding, packet inspection and user plane part of policy rule enforcement, Quality of Service (QoS) handling for user plane, downlink packet buffering and downlink data notification triggering. A location report for UE 102, e.g., including a location estimate determined by the LSS 117 in or attached to the serving gNB 110-1, may be returned by gNB 110-1 to the external client 130 via the UPF 126 and a User Plane Aggregator (UPA) 128 if present. UPF 126 may be connected to SLP 129 to enable support of location of UE 102 using SUPL. SLP 129 may be further connected to or accessible from external client 130.

The UPA 128 is optional and enables an external client 130 to receive location reports for a UE 102 by interacting only with the UPA 128. When a UPA 128 is not present and when an LSS 117 transfers a location for UE 102 to an external client 130 via user plane signaling, the external client 130 could need to directly interact with the gNB 110-1 for the UE 102, which may be less efficient (e.g. when the gNB 110-1 for a target UE 102 is changed) and/or may be a security risk for gNBs and/or the external client 130. The UPA 128 avoids the need for a gNB 110-1 (or LSS 117) to establish location reporting sessions to multiple external clients and for external clients to establish location reporting sessions to multiple gNBs 110. The UPA 128 may also provide security for the NG-RAN 112 and/or the external client 130 by authenticating and authorizing the external client 130 and/or gNB 110-1 (or LSS 117). The UPA 128 may be part of the 5GCN 150 or may be external to the 5GCN 150 (e.g. may be associated with the external client 130). In some implementations, the UPA 128 may be part of the LMF 120, GMLC 125, or may be connected to the LMF 120 or GMLC 125.

A UPA 128 may also be referred to as a router, an IP router, a UP router or as a routing function.

The LMF 120 may communicate with the gNBs 110 and/or with the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between a gNB 110 and the LMF 120, and/or between an ng-eNB 114 and the LMF 120, via the AMF 115. LMF 120 and UE 102 may communicate using an LTE Positioning Protocol (LPP), which may be defined in 3GPP TS 36.355. LMF 120 and UE 102 may also or instead communicate using a New Radio Positioning Protocol (which may be referred to as NPP or NRPP), which may be the same as, similar to, or an extension of LPP. Here, LPP and/or NPP messages may be transferred between the UE 102 and the LMF 120 via the AMF 115 and a serving gNB 110-1 or serving ng-eNB 114 for UE 102. For example, LPP and/or NPP messages may be transferred between the LMF 120 and the AMF 115 using a 5G Location Services Application Protocol (LCS AP) and may be transferred between the AMF 115 and the UE 102 using a 5G Non-Access Stratum (NAS) protocol. The LPP and/or NPP protocol may be used to support positioning of UE 102 using UE assisted and/or UE based position methods such as A-GNSS, RTK, OTDOA and/or ECID. The NRPPa protocol may be used to support positioning of UE 102 using network based position methods such as ECID (e.g. when used with measurements obtained by a gNB 110 or ng-eNB 114) and/or may be used by LMF 120 to obtain location related information from gNBs 110 and/or ng-eNB 114, such as parameters defining PRS transmission from gNBs 110 and/or ng-eNB 114.

With a UE assisted position method, UE 102 may obtain location measurements and send the measurements to a location server (e.g. LMF 120, SLP 129, or an LSS 117 (or LMC) within a node in the NG-RAN 135, such as in serving gNB 110-1) for computation of a location estimate for UE 102. For example, the location measurements may include one or more of a Received Signal Strength Indication (RSSI), Round Trip signal propagation Time (RTT), Reference Signal Time Difference (RSTD), Reference Signal Received Power (RSRP), Reference Signal Received Quality (RSRQ), carrier phase measurements for positioning, AOA, and/or AOD for gNBs 110, ng-eNB 114 and/or a WLAN access point (AP) 103. The location measurements may also or instead include measurements of GNSS pseudorange, code phase and/or carrier phase for SVs 190. With a UE based position method, UE 102 may obtain location measurements (e.g. which may be the same as or similar to location measurements for a UE assisted position method) and may compute a location of UE 102 (e.g. with the help of assistance data received from a location server such as LMF 120 or broadcast by gNBs 110, ng-eNB 114 or other base stations or APs). With a network based position method, one or more base stations (e.g. gNBs 110 and/or ng-eNB 114) or APs may obtain location measurements (e.g. measurements of RSSI, RTT, RSRP, RSRQ, AOA or Time Of Arrival (TOA)) for signals transmitted by UE 102, and/or may receive measurements obtained by UE 102, and may send the measurements to a location server (e.g. LMF 120, SLP 129, or an LSS 117 (or LMC) within a node in the NG-RAN 135, such as in serving gNB 110-1) for computation of a location estimate for UE 102. With sidelink based position method, one or more SL UEs 102 may obtain location measurements (e.g. measurements of RSSI, RTT, RSRP, RSRQ, AOA or Time Of Arrival (TOA)) for SL signals transmitted by UE 102, and/or the UE 102, operating in SL mode, may receive SL signals from one or more SL UEs 102 and obtain the location measurements from the SL signals, and the measurements may be sent a positioning entity, such as the UE 102 or a location server (e.g. LMF 120, SLP 129, or an LSS 117 (or LMC) within a node in the NG-RAN 135, such as in serving gNB 110-1) for computation of a location estimate for UE 102.

Information provided by the gNBs 110 and/or ng-eNB 114 to the location server, e.g., LMF 120 using NRPPa or to an LSS 117 within a node in the NG-RAN 135, such as in serving gNB 110-1 using XnAP, may include timing and configuration information for PRS transmission and location coordinates. The location server may then provide some or all of this information to the UE 102 as assistance data in an LPP and/or NPP message via the NG-RAN 135 and the 5GC 140.

An LPP or NPP message sent from the location server to the UE 102 may instruct the UE 102 to do any of a variety of things, depending on desired functionality. For example, the LPP or NPP message could contain an instruction for the UE 102 to obtain measurements for GNSS (or A-GNSS), WLAN, and/or OTDOA (or some other position method). In the case of OTDOA, the LPP or NPP message may instruct the UE 102 to obtain one or more measurements (e.g. RSTD measurements) of PRS signals transmitted within particular cells supported by particular gNBs 110 and/or ng-eNB 114 (or supported by some other type of base station such as an eNB or WiFi AP). An RSTD measurement may comprise the difference in the times of arrival at the UE 102 of a signal (e.g. a PRS signal) transmitted or broadcast by one gNB 110 and a similar signal transmitted by another gNB 110. The UE 102 may send the measurements back to the location server, e.g., to the LMF 120 in an LPP or NPP message (e.g. inside a 5G NAS message) via the serving gNB 110-1 (or serving ng-eNB 114) and the AMF 115 or to the LSS 117 within a node in the NG-RAN 135, such as in serving gNB 110-1.

As noted, while the communication system 100 is described in relation to 5G technology, the communication system 100 may be implemented to support other communication technologies, such as GSM, WCDMA, LTE, etc., that are used for supporting and interacting with mobile devices such as the UE 102 (e.g., to implement voice, data, positioning, and other functionalities). In some such embodiments, the 5GC 140 may be configured to control different air interfaces. For example, in some embodiments, 5GC 140 may be connected to a WLAN, either directly or using a Non-3GPP InterWorking Function (N3IWF, not shown FIG. 1) in the 5GC 140. For example, the WLAN may support IEEE 802.11 WiFi access for UE 102 and may comprise one or more WiFi APs. Here, the N3IWF may connect to the WLAN and to other elements in the 5GC 140 such as AMF 115. In some other embodiments, both the NG-RAN 135 and the 5GC 140 may be replaced by other RANs and other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120 and a GMLC that may be similar to the GMLC 125. In such an EPS, the E-SMLC may use LPPa in place of NRPPa to send and receive location information to and from the eNBs in the E-UTRAN and may use LPP to support positioning of UE 102. In these other embodiments, on-demand resource allocation for positioning of a UE 102 may be supported in an analogous manner to that described herein for a 5G network with the difference that functions and procedures described herein for gNBs 110, ng-eNB 114, AMF 115 and LMF 120 may, in some cases, apply instead to other network elements such eNBs, WiFi APs, an MME and an E-SMLC.

It should be noted that the gNBs 110 and ng-eNB 114 may not always both be present in the NG-RAN 135. Moreover, when both the gNBs 110 and ng-eNB 114 are present, the NG interface with the AMF 115 may only present for one of them.

As illustrated, a gNB 110 may be allowed to control one or more Transmission Points (TPs) 111, such as broadcast-only TPs for improved support of DL position methods such as OTDOA or ECID. Additionally, a gNB 110 may be allowed to control one or more Reception Points (RPs) 113, such as internal Location Measurement Units (LMUs) for UL measurements for position methods such as UTDOA or ECID. The TPs 111 and RPs 113 may be combined into, or defined to be part of, a Transmission Reception Point (TRP) 112 to support downlink (DL) and/or uplink (UL) position methods, such as OTDOA, UL-TDOA and multi-gNB Round Trip signal propagation Time (RTT). Further, a gNB 110 may be allowed to include a Location Server Surrogate (LSS) 117 to support positioning of a target UE 102 by a serving gNB 110. LSS 117 (or LMC) may support some or all of the same functions as LMF 120, with the difference that LSS 117 is located in NG-RAN 135, whereas LMF 120 is located in 5GCN 140. The term “Location Server Surrogate” is used herein for the NG-RAN location management functionality, but other terms may be used, such as “Local-LMF” or “NG-RAN LMF,” etc. Positioning of a UE 102 by a serving gNB 110 can be used to provide a location service to a UE 102, serving AMF 115 or LMF 120 and to improve NG-RAN operation—e.g. by reducing the latency of position determination and increasing the number of UEs 102 for which location can be supported.

As illustrated, the ng-eNB 114 may control one or more TPs 111a, which may use different protocols than TPs 111 in gNBs 110-1 and 110-2, e.g., the TPs 111a may use protocols related to LTE, while TPs 111 use protocols related to 5G NR. The TPs 111a may perform similar functions as TPs 111 in gNBs 110-1 and 110-2, and accordingly, TPs 111 and 111a may be collectively referred to herein as TPs 111.

The location management functionality in the NG-RAN 135, i.e., LSS 117, may have comparable capability to a 5GCN LMF, e.g., LMF 120). An operator could restrict an LSS 117 to support scheduling of e.g., NR Radio Access Technology (RAT) dependent positioning. The LSS 117, if present, may communicate with a gNB Central Unit (gNB-CU) and may support position determination and reporting, as described later. The LMF 120 may manage the scheduling for one or more Transmission Points (TPs) 111 that are configured to transmit downlink (DL) reference signals (RSs) to be measured by the UE 102 and one or more Reception Points (RPs) 113 that are configured to receive and measure uplink (UL) Resource Signals (RSs) transmitted by the UE 102, as well as the UL transmissions by the UE 102.

The LMF 120, SLP 129, and the LSS 117 (or LMC) in a gNB 110 may perform various functions. For example, the LMF 120 (or SLP 129) may request location measurements from the UE 102, e.g., using RRC or LPP, and may manage UL location measurements by the gNB 110 or TRP 112 of the UE 102, and may manage static and dynamic scheduling of DL-PRS and broadcast of assistance data by the gNB 110. The LMF 120 (or SLP 129) may further interact with other gNBs 110 to coordinate location support (e.g. obtain UL location measurements for a UE 102 or request changes to DL-PRS broadcast). The LSS 117 may receive the location measurements and may determine a location estimate for a UE 102. The above functions are provided as examples only. Additional or different functions may be performed if desired. An LSS 117 may communicate with other gNBs 110 using XnAP or a location specific protocol above XnAP in order to coordinate support of these functions.

Thus, an LSS 117 may support NG-RAN 135 determination of a UE 102 location which can be requested by the UE 102 (e.g., using LPP), by a serving AMF 115 (e.g., using NGAP or a location specific protocol conveyed by NGAP), by another gNB 110/ng-eNB 114 (e.g. using XnAP or a location specific protocol conveyed by XnAP), or the LMF 120 (e.g., using NRPPA protocol). Such a capability would allow location support with reduced latency in position determination (since the NG-RAN 135 is closer to a UE 102 than an LMF 120) and offload location support from LMFs.

The signaling between an AMF 115 and NG-RAN 135 node may use a protocol layering as defined in 3GPP Technical Specification (TS) 38.300 and 3GPP TS 23.501 and can make use of the Next Generation Application Protocol (NGAP) at the top level as defined in 3GPP TS 38.413. The NG-RAN 135 location reporting procedure for 3GPP Release 15 is defined in 3GPP TS 23.502 and 3GPP TS 38.413 and enables a serving AMF to request a serving NG-RAN node to report the UE location once only, periodically on a change of serving cell or periodically when a UE presence in an area of interest has changed. The location provided by the serving NG-RAN node comprises an NR or LTE Cell Global Identity CGI (CGI) and a Tracking Area Identity. The procedure may further include an optional Quality of Service (QoS) parameter in a Location Reporting Control message to enable a serving AMF 115 to request a more accurate location for a UE 102 than that corresponding to a CGI. The procedure may further include an optional list of supported Geographic Area Description (GAD) shapes in a Location Reporting Control message. The procedure may further include allowing the serving NG-RAN node to obtain a more accurate UE location when a QoS (e.g. using Enhanced Cell ID (ECID) positioning). The procedure may further permit an NG-RAN node (e.g. a gNB 110) to return a UE location to a serving AMF 115 using a GAD shape when requested in a Location Reporting Control message.

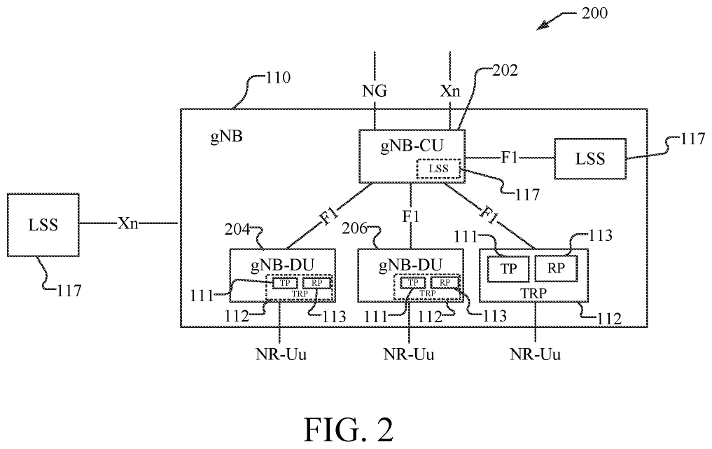

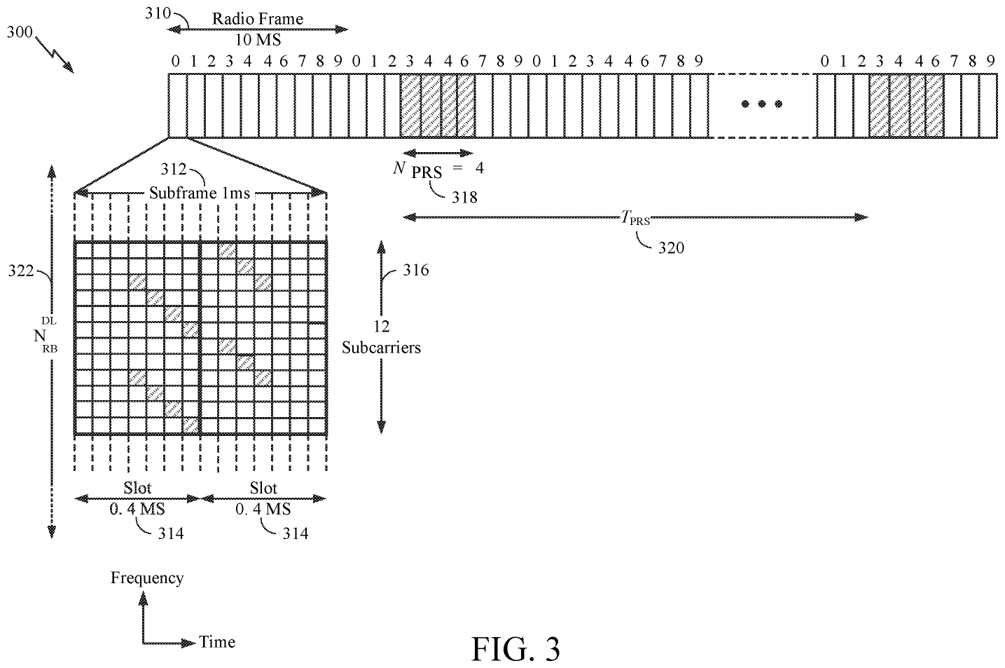

FIG. 2 shows an architecture diagram of an NG-RAN node 200, which may include an LSS 117 or may be coupled to an LSS 117 that is within the NG-RAN, e.g., as a separate entity or as part of another gNB. The NG-RAN node 200 may be a gNB 110, according to one implementation. The architecture shown in FIG. 2, for example, may be applicable to any gNB 110-1 and 110-2 in NG-RAN 135 shown in FIG. 1.

As illustrated, gNB 110 includes a gNB Central Unit (gNB-CU) 202, and gNB Distributed Units (gNB-DUs) 204 and 206, which may be physically co-located in the gNB 110 or may be physically separate. The gNB-CU 202 is a logical or physical node hosting support for RRC, SDAP and PDCP protocols of the gNB used over the NR Uu air interface and controlling the operation of one or more gNB-DUs. The gNB-CU terminates the F1 interface connected with the gNB-DU. As illustrated, the gNB-CU 202 may communicate with an AMF 115 via an NG interface. The gNB-CU 202 may further communicate with one or more other gNBs 110 via the Xn interface. The gNB-DUs 204 and 206 are logical or physical nodes hosting support for RLC, MAC and PHY protocol layers used over the NR Uu air interface of the gNB 110, operation of which is partly controlled by gNB-CU 202. The gNB-DU terminates the F1 interface connected with the gNB-CU. The gNB-CU 202 requests positioning measurements (e.g. E-CID) to the gNB-DU 204 and 206. The gNB-DU 204 and 206 reports the measurements back to the gNB-CU 202. A gNB-DU 204 or 206 may include positioning measurement functionality. It should be understood that a separate measurement node is not precluded.

The LSS 117 can be part of a gNB-CU 202 (e.g. a logical function of a gNB-CU 202). However, in order to offload positioning support from a gNB-CU 202 and to allow a multi-vendor environment, a separate LSS 117 is allowed, which may be connected to the gNB-CU 202 via an F1 interface. Additionally or alternatively, an LSS 117 within the NG-RAN 135 may be external to the gNB 110, e.g., as part of another gNB, and may be connected to the gNB 110 via an Xn interface. The gNB-CU 202 can then forward all positioning related signaling to the LSS 117 and/or gNB-DUs 204 and 206 or TRPs 112.

Additionally, as illustrated, gNB 110 may include a TP 111 and an RP 113 combined into a TRP 112, and LSS 117, which may be physically or logically located in the gNB 110. The gNB-CU 202 may be configured to communicate with the TP 111, RP 113, and LSS 117, e.g., via F1 interfaces. The gNB-CU 202, thus, controls one or more TP 111 and RP 113 and the LSS 117 is accessible from the gNB-CU 202 via an F1 interface.

In some embodiments, the NG-RAN node 200 (or gNB 110) may comprise a subset of the elements shown in FIG. 2. For example, the NG RAN node 200 may comprise the gNB-CU 202 and the LSS 117 but may not include one or more of gNB-DUs 204 and 206, RP 113 or TP 111. Alternatively, NG-RAN node 200 may include one or more of gNB-DUs 204 and 206, RP 113 or TP 111 but may not include LSS 117. Further, the elements shown in FIG. 2 may be logically separate but physically co-located or may be partially or completely physically separate. For example, LSS 117 may be physically separate from gNB-CU 202 or may be physically combined with gNB-CU 202. Similarly, one or more of gNB-DUs 204 and 206, RP 113 or TP 111 may be physically separate from gNB-CU 202 or may be physically combined with gNB-CU 202. In the case of physical separation, the F1 interface may define signaling over a physical link or connection between two separated elements. In some implementations, gNB-CU 202 may be split into a control plane portion (referred to as a CU-CP or gNB-CU-CP and a user plane portion (referred to as CU-UP or gNB-CU-UP). In this case, both the gNB-CU-CP and gNB-CU-UP may interact with gNB-DUs 204 and 206 to support NR Uu air interface signaling for control plane and user plane, respectively.

However, only the gNB-CU-CP may interact with LSS 117, TPs 111 and RPs 113 to support and control location related communication.

Protocol layering between the gNB-CU 202 and the TP 111, RP 113, and LSS 117 may be based on F1 C as defined in 3GPP TS 38.470, which uses F1AP at the top level as specified in 3GPP TS 38.473. New messages to support positioning could be added directly into F1AP or could be introduced in a new location specific protocol which is transported using F1AP.

The location procedures between the gNB-CU 202 and LSS 117 may comprise all location related procedures on NG, Xn, and NR-Uu interfaces. For example, the location procedures between AMF 115 and the NG-RAN node 200 may use NGAP.

The location procedures between NG-RAN node 200 and other NG-RAN nodes, e.g., gNBs 110, may use XnAP or a protocol above XnAP, such as an extended NR Positioning Protocol A (NRPPa) as defined in 3GPP TS 39.455. The location procedures between NG-RAN node 200 and ULE 102 may use RRC and/or LPP.

The corresponding messages to support positioning may be carried inside a transparent F1AP message transfer container. For example, the Transfer of an NGAP Location Reporting Control and NAS Transport message may be carried in an UL/DL NGAP Message Transfer. The Transfer of location related XnAP messages may be carried in an UL/DL XnAP Message Transfer. The Transfer of location related RRC(LPP) messages may be carried in an UL/DL RRC (LPP) Message Transfer.

The above support may also be realized with a single F1AP UL/DL LSS Message Transfer container and/or a new location protocol transported using F1AP. Thus, a gNB-CU 202 could forward any location related transfer messages received on NG, Xn and Uu interfaces to the LSS 117 (either within the same gNB 110 (e.g. in case the gNB includes an LSS, as illustrated in FIG. 2) or to another gNB (e.g. in case the gNB has no LSS)).

The location procedures between the LSS 117 and the gNB-DUs 204 and 206, TP 111, and RP 113, which may be coordinated by a gNB-CU 202, may include the transfer of UL/DL/SL PRS configuration and the transfer of UL/DL/SL PRS measurement information. The above functionality may be similar to that of LTE LMUs as specified in 3GPP TS 36.305 and TS 36.459 (SLmAP) and also similar to that between LMF 120 and NG-RAN node 200. Therefore, NRPPa could be extended to support TRP location measurement/configuration messages which can be carried inside F1AP transport messages.

Thus, the NG-RAN node 200 may support signaling and location procedures between a gNB-CU 202 and LSS 117 based on F1AP to support the same location procedures as supported on NG, Xn, and NR-Uu interfaces and, in addition, support transfer of a UL/DL/SL PRS configuration and measurements information to/from a gNB-DU/TRP from/to the LSS.

As can be seen, the NG-RAN location functionality (LSS) may be realized using existing interfaces and protocols. However, given that there are common location procedures on Xn, NG and F1, it would be efficient to define a new generic RAN location protocol which could be transported by Xn-C or F1-C (and probably NG) transfer messages. Given that most functionality would also be required between LMF and NG-RAN Node (i.e., to support new Rel-16 location methods and features by a 5GC LMF), it may also be possible to extend NRPPa to support the additional RAN location messages.

FIG. 3 shows a structure of an exemplary subframe sequence 300 with positioning reference signal (PRS) positioning occasions, according to aspects of the disclosure. Subframe sequence 300 may be applicable to the broadcast of PRS signals from a base station (e.g., any of the base stations described herein) or other network node. The subframe sequence 300 may be used in LTE systems, and the same or similar subframe sequence may be used in other communication technologies/protocols, such as 5G and NR. In FIG. 3, time is represented horizontally (e.g., on the X axis) with time increasing from left to right, while frequency is represented vertically (e.g., on the Y axis) with frequency increasing (or decreasing) from bottom to top. As shown in FIG. 3, downlink and uplink radio frames 310 may be of 10 millisecond (ms) duration each. For downlink frequency division duplex (FDD) mode, radio frames 310 are organized, in the illustrated example, into ten subframes 312 of 1 ms duration each. Each subframe 312 comprises two slots 314, each of, for example, 0.5 ms duration.

In the frequency domain, the available bandwidth may be divided into uniformly spaced orthogonal subcarriers 316 (also referred to as “tones” or “bins”). For example, for a normal length cyclic prefix (CP) using, for example, 15 kHz spacing, subcarriers 316 may be grouped into a group of twelve (12) subcarriers. A resource of one OFDM symbol length in the time domain and one subcarrier in the frequency domain (represented as a block of subframe 312) is referred to as a resource element (RE). Each grouping of the 12 subcarriers 316 and the 14 OFDM symbols is termed a resource block (RB) and, in the example above, the number of subcarriers in the resource block may be written as N_{SC}^{RB}=12. For a given channel bandwidth, the number of available resource blocks on each channel 322, which is also called the transmission bandwidth configuration 322, is indicated as N_{RB}^{DL}. For example, for a 3 MHz channel bandwidth in the above example, the number of available resource blocks on each channel 322 is given by N_{RB}^{DL}=15. Note that the frequency component of a resource block (e.g., the 12 subcarriers) is referred to as a physical resource block (PRB).

A base station may transmit radio frames (e.g., radio frames 310), or other physical layer signaling sequences, supporting PRS signals (i.e., a downlink (DL) PRS) according to frame configurations either similar to, or the same as that, shown in FIG. 3, which may be measured and used for a UE (e.g., any of the UEs described herein) position estimation. Other types of wireless nodes (e.g., a distributed antenna system (DAS), remote radio head (RRH), UE, AP, etc.) in a wireless communications network may also be configured to transmit PRS signals configured in a manner similar to (or the same as) that depicted in FIG. 3.

A collection of resource elements that are used for transmission of PRS signals is referred to as a “PRS resource.” The collection of resource elements can span multiple PRBs in the frequency domain and N (e.g., 1 or more) consecutive symbol(s) within a slot 314 in the time domain. For example, the cross-hatched resource elements in the slots 314 may be examples of two PRS resources. A “PRS resource set” is a set of PRS resources used for the transmission of PRS signals, where each PRS resource has a PRS resource identifier (ID). In addition, the PRS resources in a PRS resource set are associated with the same transmission-reception point (TRP). A PRS resource ID in a PRS resource set is associated with a single beam transmitted from a single TRP (where a TRP may transmit one or more beams). Note that this does not have any implications on whether the TRPs and beams from which signals are transmitted are known to the UE.

PRS may be transmitted in special positioning subframes that are grouped into positioning occasions. A PRS occasion is one instance of a periodically repeated time window (e.g., consecutive slot(s)) where PRS are expected to be transmitted. Each periodically repeated time window can include a group of one or more consecutive PRS occasions. Each PRS occasion can comprise a number N_{PRS} of consecutive positioning subframes. The PRS positioning occasions for a cell supported by a base station may occur periodically at intervals, denoted by a number T_{PRS} of milliseconds or subframes. As an example, FIG. 3 illustrates a periodicity of positioning occasions where NPRs equals 4 318 and T_{PRS} is greater than or equal to 20 320. In some aspects, T_{PRS} may be measured in terms of the number of subframes between the start of consecutive positioning occasions. Multiple PRS occasions may be associated with the same PRS resource configuration, in which case, each such occasion is referred to as an “occasion of the PRS resource” or the like.

A PRS may be transmitted with a constant power. A PRS can also be transmitted with zero power (i.e., muted). Muting, which turns off a regularly scheduled PRS transmission, may be useful when PRS signals between different cells overlap by occurring at the same or almost the same time. In this case, the PRS signals from some cells may be muted while PRS signals from other cells are transmitted (e.g., at a constant power). Muting may aid signal acquisition and time of arrival (TOA) and reference signal time difference (RSTD) measurement, by UEs, of PRS signals that are not muted (by avoiding interference from PRS signals that have been muted). Muting may be viewed as the non-transmission of a PRS for a given positioning occasion for a particular cell. Muting patterns (also referred to as muting sequences) may be signaled (e.g., using the LTE positioning protocol (LPP)) to a UE using bit strings. For example, in a bit string signaled to indicate a muting pattern, if a bit at position j is set to ‘0’, then the UE may infer that the PRS is muted for a j^{th} positioning occasion.

To further improve hearability of PRS, positioning subframes may be low-interference subframes that are transmitted without user data channels. As a result, in ideally synchronized networks, PRS may be interfered with by other cells' PRS with the same PRS pattern index (i.e., with the same frequency shift), but not from data transmissions. The frequency shift may be defined as a function of a PRS ID for a cell or other transmission point (TP) (denoted as N_{ID}^{PRS}) or as a function of a physical cell identifier (PCI) (denoted as N_{ID}^{cell}) if no PRS ID is assigned, which results in an effective frequency re-use factor of six (6).

To also improve hearability of a PRS (e.g., when PRS bandwidth is limited, such as with only six resource blocks corresponding to 1.4 MHz bandwidth), the frequency band for consecutive PRS positioning occasions (or consecutive PRS subframes) may be changed in a known and predictable manner via frequency hopping. In addition, a cell supported by a base station may support more than one PRS configuration, where each PRS configuration may comprise a distinct frequency offset (vshift), a distinct carrier frequency, a distinct bandwidth, a distinct code sequence, and/or a distinct sequence of PRS positioning occasions with a particular number of subframes (NPRs) per positioning occasion and a particular periodicity (T_{PRS}). In some implementation, one or more of the PRS configurations supported in a cell may be for a directional PRS and may then have additional distinct characteristics, such as a distinct direction of transmission, a distinct range of horizontal angles, and/or a distinct range of vertical angles.

A PRS configuration, as described above, including the PRS transmission/muting schedule, is signaled to the UE to enable the UE to perform PRS positioning measurements. The UE is not expected to blindly perform detection of PRS configurations.

Note that the terms “positioning reference signal” and “PRS” may sometimes refer to specific reference signals that are used for positioning in LTE/NR systems. However, as used herein, unless otherwise indicated, the terms “positioning reference signal” and “PRS” refer to any type of reference signal that can be used for positioning, such as but not limited to, PRS signals in LTE/NR, navigation reference signals (NRS), transmitter reference signals (TRS), cell-specific reference signals (CRS), channel state information reference signals (CSI-RS), primary synchronization signals (PSS), secondary synchronization signals (SSS), etc.

Similar to DL PRS transmitted by base stations, discussed above, a UE may transmit UL PRS for positioning to base stations and/or sidelink UEs. The UL PRS may be sometimes referred to as sounding reference signals (SRS), or SRS for positioning. Using received DL PRS from base stations, SRS transmitted to base stations, SRS transmitted to SL UEs, the various RAT dependent positioning measurements may be performed for position determination of the target UE. LTE systems, for example, use DL PRS for Observed Time Difference of Arrival (OTDOA) positioning measurements. NR systems, on the other hand, may use DL PRS for several different kinds of RAT dependent positioning measurements, such as time difference of arrival (TDOA), angle of departure (AOD), carrier-phase positioning, and may use DL PRS and SRS jointly to perform multi-cell positioning measurements, such as multi-cell Round Trip Time (M-RTT). Other types of RAT dependent positioning measurements that may be used for a position estimate for a UE include, e.g., time of arrival (TOA), reference signal time difference (RSTD), reference signal received power (RSRP), time difference between reception and transmission of signals (Rx-Tx), or angle of arrival (AoA). Other positioning methods exist, including methods that do not rely on PRS. For example, Enhanced Cell-ID (E-CID) is based on radio resource management (RRM) measurements.

With a UE assisted position method, UE 102 may obtain location measurements and send the measurements to a location server, e.g., LMF 120 or SLP 129, for computation of a location estimate for UE 102. For example, the location measurements may include one or more of a TDOA, AOD, carrier-phase positioning, M-RTT, etc. With a UE based position method, UE 102 may obtain location measurements (e.g., which may be the same as or similar to location measurements for a UE assisted position method) and may compute a location of UE 102 (e.g., with the help of assistance data received from a location server such as LMF 120 or SLP 129). With a network based position method, one or more base stations 110 or APs 103 or sidelink UEs 102′ may obtain location measurements (e.g., measurements of UL-TDOA, Rx-Tx, for signals transmitted by UE 102, and/or may receive measurements obtained by UE 102, and may send the measurements to a positioning entity, e.g., location server or UE 102, for computation of a location estimate for UE 102. The base stations 110 and/or sidelink UEs 102′ may provide information to the positioning entity, e.g., location server or UE, that may include timing and configuration information for PRS transmission and location coordinates. The location server may determine the position of the UE based on the received measurement information or may provide some or all of this information to the UE 102 as positioning assistance data to aid in detection and measurement of PRS signals from one or more base stations. The assistance data may further include locations of the base stations, which may be used by the UE 102 to calculate a position estimate in a UE based positioning process.

The location server may configure each measurement instance in a UE measurement report with at least N=1 instances of the DL-PRS Resource Set. Similarly, the location server may configure each measurement instance in a TRP measurement report with at least M=1 SRS measurement time occasions.

As discussed above, positioning measurements within a configured time window may be scheduled in advance. In one implementation, a configured time window may be a measurement time window (MTW), which is sometimes referred to as a scheduled in advance window, “that is configured by the location server, such as LMF 120 or LSS 117. The location server, e.g., LMF 120 or LSS 117, for example, may configure the measurement time window (MTW) for UE 102 for the measurement instances included in a single measurement report. The location server, e.g., LMF 120 or LSS 117, may additionally or alternatively indicate the MTW for a base station, e.g., such as gNB 110, for the measurement instances included in a single measurement report. The MTW configuration for a UE 102 or gNB 110 may include, e.g., an MTW starting time (e.g., the offset of system frame number (SFN)) and the MTW length. The MTW length, for example, may be configured with one of the following options: (explicitly) configured in the unit of 10 msec; (implicitly) decided based on the configuration of the UE 102 or gNB 110 measurement instances for the MTW, and the number of samples (PRS/SRS instances) for each UE or gNB measurement instance. The MTW configuration for a UE 102 or gNB 110 may additionally include MTW periodicity for the cases of periodic reporting.

In some implementations, the configured time window may be a processing window, such as a PRS processing window, which may be configured by a base station, such as a serving gNB 110. The PRS processing window, in some implementations, may be configured by a base station in response to a measured time window received by the base station from the location server. A PRS processing window, for example, may be configured in a UE, subject to the UE capability. The PRS processing window supports PRS measurements by the UE outside a measurement gap, e.g., inside the active DL BWP with PRS having the same numerology as the active DL BWP. The positioning measurements by the UE 102 within the PRS processing window is subject to the UE 102 determining that DL PRS to be higher priority than other DL signals/channels within the PRS processing window. For example, the PRS processing window may be supported with the UE capability for PRS prioritization over all other DL signals/channels in all symbols inside the PRS processing window. In this implementation, for example, the DL signals/channels from all DL component carriers (CCs) (per UE) are affected, or only the DL signals/channels from a certain band/CC are affected. In another example, the PRS processing window may be supported with the UE capability for PRS prioritization over other DL signals/channels only in the PRS symbols inside the window. The UE 102 may be able to declare a PRS processing capability outside MG. With the use of PRS processing window, PRS-related conditions may be specified, with one or more of the following to be down-selected, applicable to serving cell PRS only, or applicable to all PRS under conditions to PRS of non-serving cell. When the UE 102 determines higher priority for other DL signals/channels over the PRS measurement/processing, the UE 102 may not measure/process DL PRS which is applicable the above capability options.

With regards to the priority states to be indicated between PRS (serving and/or non-serving cell) and other DL signals/channels, the PRS processing window may at least support the case with two priority states, including PRS is higher priority than any other DL signals/channels excluding Synchronization Signal Block (SSB), PRS is lower priority than any other DL signals/channels including SSB.

The entity performing measurements, such as the UE 102, the base station 110, or sidelink UE 102′ provides the measurement information to the positioning entity, e.g., the location server or UE. For example, the measurement information may be provided in a Provide Location Information (PLI) message. The PLI message may be specific for the type of measurement performed, e.g., TDOA, AOD, M-RTT, carrier-phase positioning, etc. By way of example, to provide TDOA location measurements to a positioning entity, PLI message may be provided in an information element (IE) NR-DL-TDOA-ProvideLocationlnformation. The PLI IEs may also provide specific error reasons. For example, Table 1 below includes a fragment of Abstract Syntax Notation One (ASN.1) illustrating an IE NR-DL-TDOA-ProvideLocationlnformation, in which the specific error reason for the TDOA measurement is provided in an IE NR-DL-TDOA-Error-r16. It should be understood that the subscripts “-r16” may not be considered part of a parameter name and may be included only to indicate a 3GPP release in which a parameter may be defined (e.g. Release 16).

```
TABLE 1
-- ASN1START
NR-DL-TDOA-ProvideLocationInformation-r16 ::= SEQUENCE
  nr-DL-TDOA-SignalMeasurementInformation-r16
    NR-DL-TDOA-SignalMeasurementInformation-r16
      OPTIONAL,
  nr-dl-tdoa-LocationInformation-r16
    NR-DL-TDOA-LocationInformation-r16
      OPTIONAL, -- Cond UEB
  nr-DL-TDOA-Error-r16 NR-DL-TDOA-Error-r16 OPTIONAL,
  ...
}
-- ASN1STOP
```

It should be understood that for each type of measurement, e.g., TDOA, AOD, M-RTT, carrier-phase positioning, etc. a similar IE for reporting measurements and measurement errors may be used.

The IE NR-DL-TDOA-Error in Table 1 may be used by the location server or the measuring entity (e.g., UE 102, base station 110, or SL UE 102′) to provide the NR DL-TDOA error reasons to the positioning entity (e.g., UE 102 or location server), respectively. Table 2 below, for example, includes a fragment of ASN.1 illustrating an IE NR-DL-TDOA-Error.

TABLE 2

```
-- ASN1START
NR-DL-TDOA-Error-r16 ::= CHOICE {
  locationServerErrorCauses-r16
    NR-DL-TDOA-LocationServerErrorCauses-r16,
  targetDeviceErrorCauses-r16
    NR-DL-TDOA-TargetDeviceErrorCauses-r16,
  ...
}
-- ASN1STOP
```

Additionally, the location server, e.g., the LMF 120 or SLP 129, may send an error cause to the UE 102, e.g., typically with regards to the assistance data. For example, the UE 102 may request assistance data, and the LMF 120 may be unable to provide assistance data and may provide an error cause to the UE 102. Table 3 below, for example, includes a fragment of ASN.1 illustrating an IE OTDOA-LocationServerErrorCauses for location server error reasons, in this case for OTDOA, but similar error reasons may be provided to the UE 102 for other positioning methods.

```
TABLE 3
-- ASN1START
OTDOA-LocationServerErrorCauses ::= SEQUENCE {
  cause ENUMERATED { undefined,
      assistanceDataNotSupportedByServer,
      assistanceDataSupportedButCurrentlyNotAvailableByServer,
      ...
    },
  ...
}
-- ASN1STOP
```

The IE NR-DL-TDOA-TargetDeviceErrorCauses may be used by the measuring entity (e.g., UE 102, base station 110, or SL UE 102′) to provide the NR DL-TDOA error reasons to the positioning entity, e.g., location server or UE 102. Table 4 below, for example, includes a fragment of ASN.1 illustrating an IE NR-DL-TDOA-TargetDeviceErrorCauses.

```
TABLE 4
-- ASN1START
NR-DL-TDOA-TargetDeviceErrorCauses-r16 ::= SEQUENCE {
  cause-r16 ENUMERATED { undefined,
      assistance-data-missing,
      unableToMeasureAnyTRP,
      attemptedButUnableToMeasureSomeNeighbourTRPs,
      thereWereNotEnoughSignalsReceivedForUeBasedDL-TDOA,
      locationCalculationAssistanceDataMissing,
      ...
    },
  ...
}
-- ASN1STOP
```

If the measuring entity, e.g., the UE 102, base station 110, or SL UE 102′, is configured with a configured time window, e.g., a measurement time window or PRS processing window, but is unable to obtain positioning measurements within the configured time window, the measuring entity may report an error message to the positioning entity indicating that the measuring entity attempted but was unable to obtain one or more measurements in the configured time window. By way of example, the NR-DL-TDOA-TargetDeviceErrorCauses-r16 in Table 4 may include an additional enumerated reason indicating that the measuring entity was unable to measure within the configured window, e.g., “attemptedButUnableToMeasureWithinConfiguredWindow.” It should be understood that while Table 4 addresses TDOA, the indication that the measuring entity attempted but was unable to obtain one or more measurements in the configured time window may be included in messages for any type of measurement, including GNSS pseudorange, a GNSS codephase, a GNSS carrier phase, a WiFi measurement (RSSI, AOA or RTT), a Bluetooth measurement (RSSI, AOA or RTT), a measurement of DL NR signals from a gNB (RSTD, RSRP, RSRQ, AOD, AOA, Rx-Tx, carrier-phase), a measurement of UL NR signals from the UE (AOA, RSRP, Rx-Tx, TOA), a measurement performed by a sensor (inertial sensor, barometer), etc.

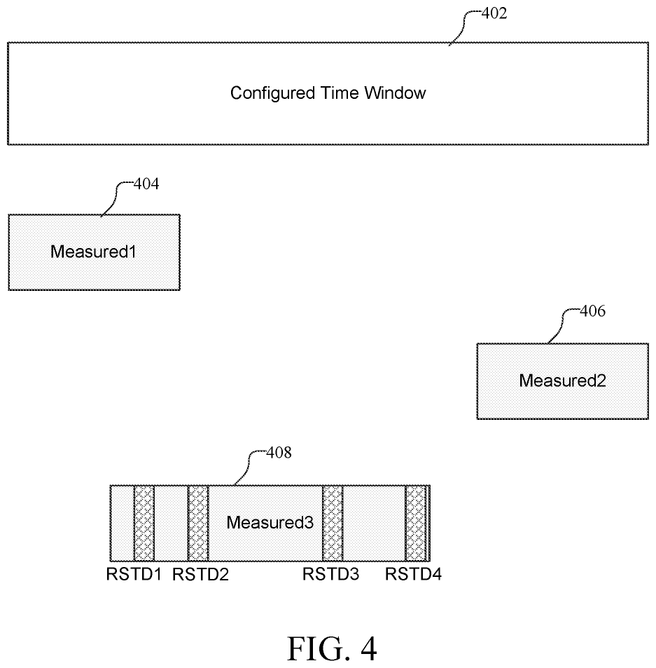

FIG. 4 illustrates, for example, a configured time window 402, e.g., a measurement time window or PRS processing window, for obtaining positioning measurements by a measuring entity, e.g., the UE 102, base station 110, or SL UE 102′. The measuring entity may be able unable to obtain one or more positioning measurements during the configured time window 402. For example, as illustrated by measured1 window 404, the measuring entity may be able to obtain positioning measurements in the beginning of the configured time window, but not until the end of the configured time window. As illustrated by measured2 window 406, the measuring entity may be unable to obtain positioning measurements in the beginning of the configured time window, but able to obtain positioning measurements at the end of the configured time window. As illustrated by measured3 window 408, the measuring entity may be able to obtain positioning measurements at some portion of the configured time window that is neither in the start or end of the configured time window, but is otherwise unable to obtain positioning measurements in the configured time window.

Within each measured window 404, 406, and 408, the measuring entity may be able to perform one or more positioning measurements. For example, measured3 window 408 illustrates four positioning measurements (RSTD1, RSTD2, RSTD3, and RSTD4) within the measured window. It should be understood that each positioning measurement within a measured window 404, 406, and 408 may be reported within the PLI report to the positioning entity and may include a time stamp. This information alone, however, may be insufficient for the positioning entity to determine whether errors occurred during positioning. For example, using only time stamps associated with each positioning measurement, the positioning entity will not be able to determine if the measuring entity was able to obtain positioning measurements throughout the configured time window and only reported the best positioning measurements, or if errors occurred at different times during the configured time window and positioning measurements could not be obtained.

Accordingly, in some implementations, if the measuring entity, e.g., the UE 102, base station 110, or SL UE 102′, is able to obtain one or more positioning measurements during the configured time window, but is unable to obtain positioning measurements throughout the configured time window, the error message reported by the measuring entity may specify the portion or portions of the configured time window during which it was unable to obtain positioning measurements. For example, if the measuring entity, e.g., the UE 102, base station 110, or SL UE 102′, could obtain positioning measurements in the beginning of the configured time window, but could not obtain positioning measurements until the end of the configured time window (e.g., as illustrated by measured1 window 404), the measuring entity may indicate in the error message that it was unable to obtain positioning measurements until an end of the configured time window, e.g., “attemptedButUnableToMeasureUntilTheEndOfConfiguredWindow,” may be an enumerated error reason. In another example, if the measuring entity, e.g., the UE 102, base station 110, or SL UE 102′, could not obtain positioning measurements in the beginning of the configured time window, but could obtain positioning measurements until the end of the configured time window (e.g., as illustrated by measured2 window 406), the measuring entity may indicate in the error message that it was unable to obtain positioning measurements at a start of the configured time window, e.g., “attemptedButUnableToStartMeasuringAtTheConfiguredStartTime,” may be an enumerated error reason. In another example, if the measuring entity, e.g., the UE 102, base station 110, or SL UE 102′, may be able to obtain positioning measurements at some portion of the configured time window that is neither in the start or end of the configured time window, but is otherwise unable to obtain positioning measurements in the configured time window (e.g., as illustrated by measured3 window 408), the measuring entity may indicate in the error message the actual measured window within the configured time window, e.g., by providing a start and an end (or duration) of the one or more measured windows.

In some implementations, the measuring entity, e.g., the UE 102 or SL UE 102′, may attempt to obtain positioning measurements but may fail, e.g., because it did not receive a PRS processing window configuration from the serving base station. If the measuring entity, e.g., the UE 102 or SL UE 102′, attempted to obtain positioning measurements during the configured time window, but could not because it did not receive a PRS processing window, the measuring entity may indicate in the error message that it was unable to obtain positioning measurements because it did not receive the PRS processing window, e.g., “attemptedButDidNotReceivePRSProcessingWindow,” may be an enumerated error reason.

In some implementations, the measuring entity, e.g., the UE 102 or SL UE 102′, may be configured with a PRS processing window, but may not obtain positioning measurements during the configure time window (e.g., during the PRS processing window) for one or more reasons, such as the PRS priority is low (i.e., lower than the priority of other signals or channels). If the measuring entity, e.g., the UE 102 or SL UE 102′, received the PRS processing window, but could not obtain positioning measurements because the PRS priority is low, the measuring entity may indicate in the error message that it was unable to obtain positioning measurements because the PRS priority is low within the PRS processing window, e.g., “attemptedButPRSPrioritylsLowWithinProcessingWindow,” may be an enumerated error reason.

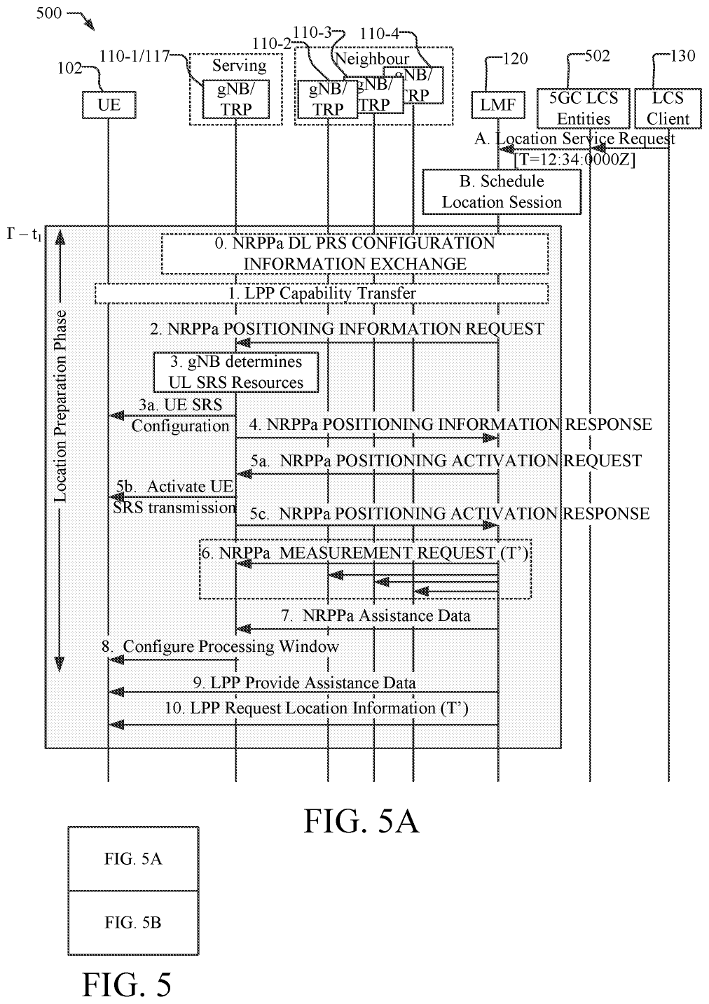

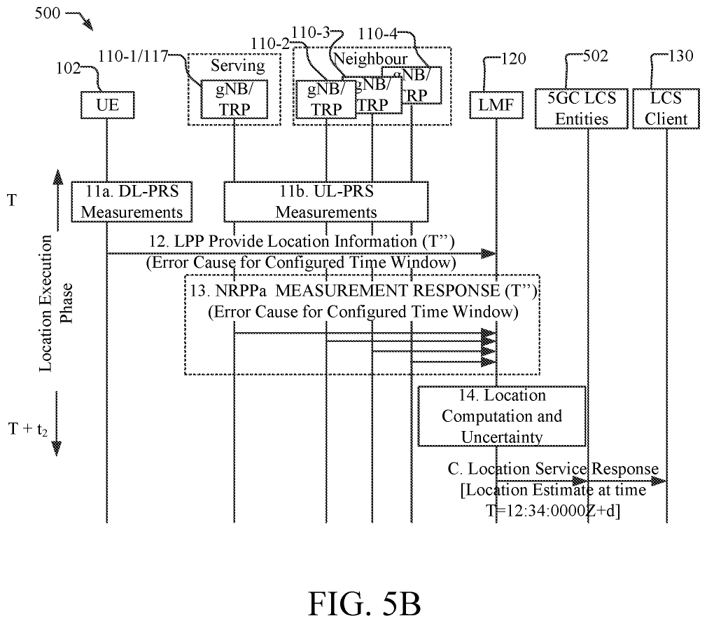

FIG. 5, which as illustrated by the diagram key, is comprised of FIGS. 5A and 5B, is a message flow 500 illustrating the messaging between an LCS client 130, 5GC LCS entities 502 (such as GMLC 125 or AMF 115 and NEF 127), the LMF 120, the gNBs 110, and the UE 102 for positioning using a configured time window and reporting a configured time window error. The message flow 500 illustrates multi-RTT positioning procedure as described in TS 38.305 in which the time for location determination of the UE is scheduled in advance, but other types of positioning measurements may be performed. The serving gNB 110-1 and multiple neighboring gNBs 110-2, 110-3, and 110-4 may be sometimes gNBs collectively referred to as gNBs 110. While the use of LMF 120 is illustrated in FIG. 5, it should be understood that other entities may be used as the positioning entity in place of the LMF 120 for determining the location and uncertainty of the location of the UE 102 including, e.g., an SLP 129, or LSS 117 (or LMC) in the NG-RAN 135, or the UE 102. For example, the LSS 117 may be a logical function of the serving gNB 110-1 CU. In some implementations, the LSS 117 may be inside the gNB 110-1, but connected to the CU or outside the gNB 110-1. For example, if the LSS 117 is outside the gNB 110-1 or separate from the gNB 110-1 CU, additional messages (e.g. XnAP messages) may be used to transfer messages from the gNB 110-1 to the LSS 117 and back from the LSS 117 to the gNB 110-1.

The positioning procedure illustrated in FIG. 5 includes both DL PRS and UL SRS for the sake of inclusiveness. The DL PRS and UL SRS measurements, for example, may be used to support a positioning method such as multi-cell RTT (also referred to as multi-RTT) in which UE 102 obtains DL measurements and gNBs 110 obtain UL measurements. It should be understood, however, that the procedure illustrated in FIG. 5 may be used with other types of positioning methods that rely, e.g., on only DL PRS by excluding the stages related to UL SRS, or that rely on only UL SRS by excluding the stages related to DL PRS, or that additionally or alternatively rely on SL SRS with one or more sidelink UEs 102′. Accordingly, the procedure may be used with positioning measurements, such as UL TDOA, UL AOA, DL TDOA, DL AOD, A-GNSS, WLAN, RTT, multi-cell RTT or some combination of these. For example, to support UL position methods such as UL TDOA or UL AOA in which gNBs 110 measure UL SRS signals from UE 102 but UE 102 does not measure DL PRS signals from gNBs 110 or other DL signals (e.g. from SVs 190 or a WLAN AP), stages 0, 7, 8, 11a and 12 in FIG. 5 may be omitted. Similarly, to support DL position methods such as DL TDOA, DL AOD, A-GNSS or WLAN in which UE 102 measures DL PRS signals from gNBs 110 or other DL signals (e.g. from SVs 190 or a WLAN AP) but gNBs 110 do not measure UL SRS signals from UE 102, stages 2-4, 5-6, 11b and 13 in FIG. 5 may be omitted.

As illustrated in FIG. 5, the positioning procedure may request and schedule the location of the UE 102 in advance of when it is needed, e.g., at time T. Accordingly, on the left side of the message flow is a timeline illustrating when various stages are performed relative to the time T. As illustrated, stages 0-10 (illustrated in FIG. 5A) are all part of the location preparation phase and are performed before time T. At time T, the UL and DL signals are transmitted and measured. After time T, the location execution phase occurs, which is illustrated as including stages 11-14 and C (illustrated in FIG. 5B). The message flow 500 illustrates the use of the LMF 120 for position determination, but if desired, the LSS 117 (or LMC) in the serving gNB 110-1, or the UE 102 itself, may be used to further reduce latency in the positioning procedure, e.g., during the location execution phase.

At stage A, the Location Service Request from an LCS Client 130 is sent to the LMF 120 via one or more 5GC LCS entities 502, and includes the desired location time T in a format suitable for the LCS client 130. In this example, the location time may be provided in UTC and defines the request to obtain the target device location at T=12:34:0000Z in the future. The request may include the required uncertainty for the location for the UE, which may be a maximum difference (e.g. maximum distance) between an estimated location and the actual location of the UE at the scheduled location time. The request, for example, may include a time window or uncertainty t for the location time; i.e., the desired location time is then T±t seconds. The location time uncertainty t can be expressed in two alternative ways. One option (A) is to explicitly specify t. The other option (B) is to include location time uncertainty as part of location uncertainty which is treated as the uncertainty or error in the UE location at time T. For example, assume the UE 102 is at location L at time T, at location L1 at a time T1 (close to T) and that a location L2 is obtained for the UE at time T1. Then with option A, the location error is L1-L2 and the time error is T-T1. With option B, the location error is L-L2 and there is no time error. Option B may require a more complex LMF 120 (or SLP 129, LSS 117 or UE 102) implementation which would need to determine location uncertainty based on both error in location and error in time as discussed for FIG. 5. Thus, in implementations in which a combined location and time uncertainty is supported for a scheduled location time, a time window or uncertainty t may not be provided at stage A, and instead just a required location accuracy (e.g. a maximum location error) may be provided, based on support of Option B. However, a location server (e.g. LMF 120) may still determine a time window or uncertainty t which is not visible to an LCS Client 130 which may be used to help support a required location accuracy specified by the LCS Client 130.

At stage B, the LMF 120 schedules the location session for the target UE 102 such that the UE location can be obtained (as close as possible) for the requested time T (i.e., in this example the UE location valid at time T=12:34:0000Z).

The Location Preparation Phase starts with stage 0 at time T-t₁, where t₁ depends on the expected duration of the location preparation phase (which depends on e.g. selected positioning method, etc.).

At stage 0, the LMF 120 and gNBs 110 may use a NRPPa DL PRS configuration information exchange, e.g., as described in 3GPP TS 38.305, to obtain from gNBs 110 or send to gNBs 110 DL PRS configuration information (e.g. including parameters for DL PRS transmission such as PRS frequency, bandwidth, timing, coding, muting, frequency hopping) required for a positioning method, e.g., Multi-RTT positioning. The PRS configuration information can also be sent as assistance data to UE 102 (at stage 7) and/or to LSS 117 (not shown). The PRS configuration information can be used by: UE 102 to assist DL PRS measurements at stage 11a; LMF 120 to request UL SRS configuration information from the serving gNB 110-1 for the UE 102 at stage 2; and/or by LSS 117 to assist calculation of the UE 102 location.

At stage 1, the LMF 120 may request the positioning capabilities of the UE 102 using a LPP Capability Transfer procedure, e.g., described in 3GPP TS 38.305.

At stage 2, the LMF 120 sends a NRPPa POSITIONING INFORMATION REQUEST message to the serving gNB 110-1 to request UL information for the UE 102.

At stage 3, the serving gNB 110-1 determines the resources available for UL SRS and configures the UE 102 with the UL-SRS resource sets at stage 3a.

At stage 4, the serving gNB 110-1 provides the UL SRS configuration information to the LMF 120 in a NRPPa POSITIONING INFORMATION RESPONSE message.

At stage 5a, the LMF 120 sends an NRPPa POSITIONING ACTIVATION REQUEST, requesting UE SRS activation message to the serving gNB 110-1. The Request UE SRS activation message includes the time T at which the location for the UE 102 is to be measured and thus the time at which UE 102 needs to transmit UL SRS to enable the UL measurements at stage 9b to occur at or near to the time T. At stage 5b, the serving gNB 110-1 activates the UE SRS transmission, at or near to the time T. The UE 102 will wait until at or near to the time T to begin the UL SRS transmission. At stage 5c, the serving gNB 110-1 sends an NRPPa POSITIONING ACTIVATION RESPONSE message to the LMF 120 indicating SRS activation of the UE 102.

At stage 6, the LMF 120 provides the UL information to the selected gNBs 110 in a NRPPa MEASUREMENT REQUEST message. The message includes an indication of the physical measurement time T′ to perform the UL measurements. The time T′ ultimately defines the time when the target device location is valid/obtained. The time T′ may specify an SFN/slot for example. The time T′ has a 1:1 relation to T (e.g., 1:1 relation to UTC as requested at stage A). The message includes all information required to enable the gNBs/TRPs 110 to perform the UL measurements.

At stage 7, the LMF 120 sends an NRPPa Assistance Data message to the serving gNB 110-1, e.g., indicating the measurement time window for position measurements. The MTW, for example, may be configured by specifying an MTW staring time, e.g., the offset of SFN, and may include the MTW length, e.g., either a configured unit of time (slots) or may be implicitly based on the configuration of the UE/gNB measurement instances for the MTW and the number of samples (PRS/SRS instances) for each UE/gNB measurement instance. The MTW may further include the periodicity.

At stage 8, the serving gNB 110-1 may send configure the UE 102 with a PRS processing window in response to receiving the measurement time window from the LMF 120 in stage 7.

At stage 9, the LMF 120 sends a LPP Provide Assistance Data message to the UE 102. The message includes any required assistance data for the UE 102 to perform the necessary DL PRS measurements (e.g. includes PRS configuration information sent or received by LMF 120 at stage 0).

At stage 10, the LMF 120 sends a LPP Request Location Information message to the UE 102 to request DL measurements (e.g. UE Rx-Tx) to support Multi-RTT. The Request Location Information message includes an indication of the scheduled location time T′ and the measurement time window. The NRPPa Measurement Request at stage 6 and/or the LPP Request Location Information at stage 10 includes a physical measurement time T′ when the location measurements are to be obtained. The time T′ ultimately defines the time when the target device location is valid/obtained. The time T′ may specify an SFN/slot for example. The time T′ has a 1:1 relation to T (e.g., 1:1 relation to UTC as requested at stage A). Similar to the NRPPa Measurement Request at stage 6, the LPP Request Location Information may configure the MTW, for example, by specifying an MTW staring time, e.g., the offset of SFN, and may include the MTW length, e.g., either a configured unit of time (slots) or may be implicitly based on the configuration of the UE/gNB measurement instances for the MTW and the number of samples (PRS/SRS instances) for each UE/gNB measurement instance. The MTW may further include the periodicity. The Request Location Information message may further indicate the type of positioning method to be used, e.g., UE assisted multi-RTT.

At stage 11a, at or near to the time T, the UE 102 attempts to perform location measurements, e.g., of the DL PRS measurements such as RSTD, RSRP, RSRQ, AOD, AOA, Rx-Tx from all gNBs 110 provided in the assistance data at stage 9. The UE 102 attempts to perform the measurements within the configured time window such that the measurements/location is valid at time T′ (the physical time base corresponding to T). The location measurements may additionally or alternatively include at least one of a GNSS pseudorange, a GNSS codephase, a GNSS carrier phase, a WiFi measurement (RSSI, AOA or RTT), a Bluetooth measurement (RSSI, AOA or RTT), a measurement of DL NR signals from a gNB (RSTD, RSRP, RSRQ, AOD, AOA, Rx-Tx, carrier phase), a measurement performed by a sensor, such as an inertial sensor, barometer, etc. For purposes of the present flow chart, the UE 102 is unable to obtain one or more positioning measurements within the configured time window. For example, the UE 102 may be unable to obtain one or more positioning measurements until the end of the configured time window, at the start of the configured time window, or may obtain positioning measurements within a measured window but not throughout the configured time window. In some implementations, the UE 102 may be unable to obtain one or more positioning measurements because it did not receive the processing window (at stage 8) or, while it did receive the processing window, the PRS had low priority (e.g., lower than DL signals or channels) within the processing window.

At stage 11b, at or near to the time T, each gNB 110 configured at stage 5 attempts to measure the UL SRS transmissions from the UE 102, such as AOA, RSRP, Rx-Tx, TOA, or carrier phase. The gNBs 110 attempt to perform the measurements within the configured time window such that the measurements/location is valid at time T′ (the physical time base corresponding to T). For purposes of the present flow chart, one or more gNBs 110 are unable to obtain one or more positioning measurements within the configured time window. For example, one or more gNBs 110 may be unable to obtain one or more positioning measurements until the end of the configured time window, at the start of the configured time window, or may obtain positioning measurements within a measured window but not throughout the configured time window.

In some implementations, one or more SL UEs 102′ (not shown) may be configured to measure SL SRS transmissions from the UE 102, such as AOA, RSRP, Rx-Tx, TOA, or carrier phase. The one or more SL UEs 102′ attempt to perform the measurements within the configured time window such that the measurements/location is valid at time T′ (the physical time base corresponding to T). For purposes of the present flow chart, one or more SL UEs 102′ are unable to obtain one or more positioning measurements within the configured time window. For example, one or more gNBs 110 may be unable to obtain one or more positioning measurements until the end of the configured time window, at the start of the configured time window, or may obtain positioning measurements within a measured window but not throughout the configured time window.

The measuring entities, e.g., UE 102 and/or the gNBs 110 at stages 11a and 11b (and SL UEs 102′ if present), thus attempt to obtain a plurality of measurements within the configured time window that includes the scheduled location time T. For example, the measurements may occur within a time period that is less than 1 second, less than 100 ms, less than 10 ms or less than 1 ms. One or more of the measuring entities may be unable to obtain the positioning measurements during the configured time window.

At stage 12, the UE 102 reports the measurements performed at stage 11a to the LMF 120 in a LPP Provide Location Information message, which may identify the time T″. The location report at stage 12 includes the measurements/location estimate together with the time stamp T″ (where T″ is as close as possible to the requested time T′; i.e., ideally T″=T′). The location time error is then 6=(T″−T′). The UE 102 may provide an indication of its velocity and/or a distance moved between time T′ and time T″ or measurements (e.g. sensor measurements) that allow LMF 120 to determine UE 102 velocity or distance moved. The UE 102 may include an error message in the report that includes an error cause for the configured time window. For example, as discussed above, the UE 102 may provide an indication that it attempted to obtain positioning measurements during the configured time window, but was unable to obtain one or more positioning measurements. The UE 102 may provide an indication of the portion(s) of the configured time window when the positioning measurements could not be obtained, e.g., at the start of the configured time window, the end of the configured time window or some other portion. In some implementations, the UE 102 may indicate the time when measurements could be obtained, i.e., the actual measured window within the configured time window, by indicating the start and end (or duration) times, where positioning measurements could not be obtained at other times in the configured time window. The UE 102 may further provide indications of why it could not obtain the positioning measurements, e.g., it did not receive a processing window from the server gNB 110-1 or the PRS priority was low (e.g., lower than DL signals or channels) within the processing window.

At stage 13, each of the neighboring gNBs 110-2, 110-3, and 110-4 reports the measurements performed at stage 11b to the LMF 120 in NRPPa Measurement Response messages, which may identify the time T′″. The location report at stage 13 includes the measurements/location estimate together with the time stamp T″ (where T″ is as close as possible to the requested time T′; i.e., ideally T″=T′). The location time error is then 6=(T″−T′). Any gNB 110 that could not obtain one or more measurements during the configured time window may include an error message in the report that includes an error cause for the configured time window. For example, as discussed above, the gNB 110 may provide an indication that it attempted to obtain positioning measurements during the configured time window, but was unable to obtain one or more positioning measurements. The gNB 110 may provide an indication of the portion(s) of the configured time window when the positioning measurements could not be obtained, e.g., at the start of the configured time window, the end of the configured time window or some other portion. In some implementations, the gNB 110 may indicate the time when measurements could be obtained, i.e., the actual measured window within the configured time window, by indicating the start and end (or duration) times, where positioning measurements could not be obtained at other times in the configured time window.

If a SL UE 102′ is present, the SL UE 102′ may similarly report the measurements of SL SRS performed by the SL UE 102′ to the LMF 120 (or to UE 102) in a Provide Location Information message, which may identify the time T″. The location report may include the measurements/location estimate together with the time stamp T″ (where T″ is as close as possible to the requested time T′; i.e., ideally T″=T′). The location time error is then 6=(T″−T′). The SL UE 102′ may provide an indication of its velocity and/or a distance moved between time T′ and time T″ or measurements (e.g. sensor measurements) that allow LMF 120 (or UE 102) to determine the SL UE 102 velocity or distance moved. The SL UE 102′ may include an error message in the report that includes an error cause for the configured time window. For example, as discussed above, the SL UE 102′ may provide an indication that it attempted to obtain positioning measurements during the configured time window, but was unable to obtain one or more positioning measurements. The SL UE 102′ may provide an indication of the portion(s) of the configured time window when the positioning measurements could not be obtained, e.g., at the start of the configured time window, the end of the configured time window or some other portion. In some implementations, the SL UE 102′ may indicate the time when measurements could be obtained, i.e., the actual measured window within the configured time window, by indicating the start and end (or duration) times, where positioning measurements could not be obtained at other times in the configured time window. The SL UE 102′ may further provide indications of why it could not obtain the positioning measurements, e.g., it did not receive a processing window from the server gNB 110-1 or the PRS priority was low (e.g., lower than DL signals or channels) within the processing window.

At stage 14, the LMF 120 determines the location of the UE 102 based on the measurements received at stages 12 and 13 (and from the SL UE 102′ if present). For example, the LMF 120 may determine the RTTs from the UE 102 and gNB 110 Rx-Tx Time Difference Measurements for each gNB 110 for which corresponding UL and DL measurements were provided at stages 12 and 13 and calculate the position of the UE 102. The LMF 120 further determines an uncertainty of the location. The LMF 120, for example, may determine the location of the UE with an uncertainty that does not exceed the required uncertainty indicated at stage A. The location for the UE may be an estimate of the actual location of the UE at a time T1 that is within the measurement time window that includes the scheduled location time, which, for example, may be less than 1 second, less than 100 ms, less than 10 ms or less than 1 ms. The LMF 120 may use the error messages received in stages 12 and 13 in the determination of the location of the UE 102, as well as to assist in reconfiguration of PRS/SRS configuration in later positioning sessions.

It should be understood that while stage 14 illustrates the LMF 120 determining the location and uncertainty of the UE 102, other entities may perform this stage including the UE 102, the SLP 129, a gNB 110, the LSS 117 (or an LMC in an NG-RAN 135).

At stage C, the LMF 120 sends a Location Service Response to the LCS client 140 via the one or more 5GC LCS entities 502, which provides the target device location and the location uncertainty that indicates a difference between the location and the actual location of the UE at the scheduled location time T. In this example, a time stamp could also be included indicating a location time is T=12:34:0000Z+δ. This location estimate is received by the LCS client at time T+t2 (i.e., at T=12:34:0000Z+6+t2 in this example), where t2 is the latency and δ is the difference between the requested and actual location time.

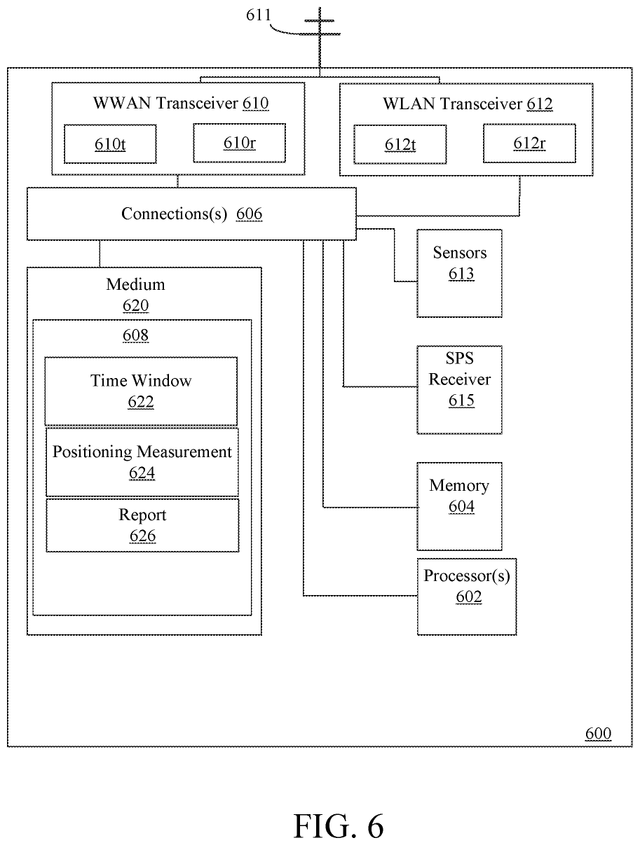

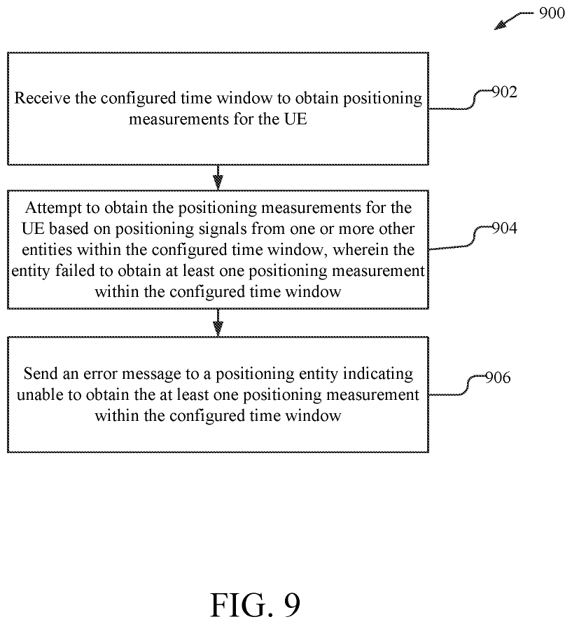

FIG. 6 shows a schematic block diagram illustrating certain exemplary features of a UE 600, e.g., which may be UE 102 or a SL UE 102′, that is configured for supporting positioning using a configured time window and reporting a configured time window error, e.g., as discussed herein. The UE 600, for example, may perform the message flow 500 illustrated in FIG. 5 and the procedure 900 illustrated in FIG. 9 along with other algorithms discussed herein.

The UE 600 may, for example, include one or more processors 602, memory 604, an external interface such as at least one wireless transceivers (e.g., wireless network interface) illustrated as WWAN transceiver 610 and WLAN transceiver 612, SPS receiver 615, and one or more sensors 613, which may be operatively coupled with one or more connections 606 (e.g., buses, lines, fibers, links, etc.) to non-transitory computer readable medium 620 and memory 604. The SPS receiver 615, for example, may receive and process SPS signals from SVs 190 shown in FIG. 1 to measure GNSS pseudorange, a GNSS codephase, a GNSS carrier phase, etc. The one or more sensors 613, for example, may be an inertial measurement unit (IMU) that may include one or more accelerometers, one or more gyroscopes, a magnetometer, barometer, etc. The UE 600 may further include additional items, which are not shown, such as a user interface that may include e.g., a display, a keypad or other input device, such as virtual keypad on the display, through which a user may interface with the UE. In certain example implementations, all or part of UE 600 may take the form of a chipset, and/or the like.

The UE 600 may include at least one wireless transceiver, such as transceiver 610 for a WWAN communication system and transceiver 612 for a WLAN communication system, or a combined a transceiver for both WWAN and WLAN. The WWAN transceiver 610 may include a transmitter 610t and receiver 610r coupled to one or more antennas 611 for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The WLAN transceiver 612 may include a transmitter 612t and receiver 612r coupled to one or more antennas 611 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The transmitters 610t and 612t may include multiple transmitters that may be discrete components or combined/integrated components, and/or the receivers 610r and 612r may include multiple receivers that may be discrete components or combined/integrated components. The WWAN transceiver 610 may be configured to communicate signals (e.g., with base stations and/or one or more other devices) according to a variety of radio access technologies (RATs) such as 6G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), etc. New Radio may use mm-wave frequencies and/or sub-6 GHz frequencies. The WLAN transceiver 612 may be configured to communicate signals (e.g., with access points and/or one or more other devices) according to a variety of radio access technologies (RATs) such as 3GPP LTE-V2X (PC5), IEEE 602.11 (including IEEE 602.11p), WiFi, WiFi Direct (WiFi-D), Bluetooth®, Zigbee etc. The transceivers 610 and 612 may be communicatively coupled to a transceiver interface, e.g., by optical and/or electrical connection, which may be at least partially integrated with the transceivers 610 and 612.

In some embodiments, UE 600 may include antenna 611, which may be internal or external. UE antenna 611 may be used to transmit and/or receive signals processed by wireless transceivers 610 and 612. In some embodiments, UE antenna 611 may be coupled to wireless transceivers 610 and 612. In some embodiments, measurements of signals received (transmitted) by UE 600 may be performed at the point of connection of the UE antenna 611 and wireless transceivers 610 and 612. For example, the measurement point of reference for received (transmitted) RF signal measurements may be an input (output) terminal of the receiver 610r (transmitter 610t) and an output (input) terminal of the UE antenna 611. In a UE 600 with multiple UE antennas 611 or antenna arrays, the antenna connector may be viewed as a virtual point representing the aggregate output (input) of multiple UE antennas. In some embodiments, UE 600 may measure received signals including signal strength and TOA measurements, and angle related measurements for DL PRS and/or SL PRS and the raw measurements may be processed by the one or more processors 602, including RSTD, RSRP, RSRQ, AOD, AOA, Rx-Tx, etc., of DL NR signals from a gNB or SL SRS from a SL UE 102′, or WiFi measurements such as RSSI, AOA or RTT, Bluetooth measurement such as RSSI, AOA or RTT, etc.

The one or more processors 602 may be implemented using a combination of hardware, firmware, and software. For example, the one or more processors 602 may be configured to perform the functions discussed herein by implementing one or more instructions or program code 608 on a non-transitory computer readable medium, such as medium 620 and/or memory 604. In some embodiments, the one or more processors 602 may represent one or more circuits configurable to perform at least a portion of a data signal computing procedure or process related to the operation of UE 600.

The medium 620 and/or memory 604 may store instructions or program code 608 that contain executable code or software instructions that when executed by the one or more processors 602 cause the one or more processors 602 to operate as a special purpose computer programmed to perform the techniques disclosed herein. As illustrated in UE 600, the medium 620 and/or memory 604 may include one or more components or modules that may be implemented by the one or more processors 602 to perform the methodologies described herein. While the components or modules are illustrated as software in medium 620 that is executable by the one or more processors 602, it should be understood that the components or modules may be stored in memory 604 or may be dedicated hardware either in the one or more processors 602 or off the processors.

A number of software modules and data tables may reside in the medium 620 and/or memory 604 and be utilized by the one or more processors 602 in order to manage both communications and the functionality described herein. It should be appreciated that the organization of the contents of the medium 620 and/or memory 604 as shown in UE 600 is merely exemplary, and as such the functionality of the modules and/or data structures may be combined, separated, and/or be structured in different ways depending upon the implementation of the UE 600.

The medium 620 and/or memory 604 may include a time window module 622 that when implemented by the one or more processors 602 configures the one or more processors 602 to receive from a location server or serving base station, e.g., via one of the transceivers 610, 612, the configured time window to obtain positioning measurements for the UE location measurements. The configured time window, for example, may be, e.g., a measurement time window, a PRS processing window, or a combination thereof.

The medium 620 and/or memory 604 may include a positioning measurements module 624 that when implemented by the one or more processors 602 configures the one or more processors 602 to obtain positioning measurements, e.g., via the transceivers 610, 612, the sensors 613, or SPS receiver 615, for the UE based on positioning signals from one or more other entities, e.g., a serving base station, a neighboring base station, or SL UEs, within the configured time window. The positioning measurements, for example, may include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of sidelink signals from a sidelink UE comprising at least one of AOA, RSRP, Rx-Tx, TOA, measurement performed by a sensor comprising at least one of an inertial sensor or a barometer.

The medium 620 and/or memory 604 may include a report module 626 that when implemented by the one or more processors 602 configures the one or more processors 602 to send a report to a positioning entity (e.g., the target UE or location server) for the positioning measurements, via the transceivers 610, 612, such as a PLI report, which may include an error message. In some implementations, e.g., where the UE 600 is the positioning entity, the one or more processors 602 may be configured to receive a report from a positioning entity (e.g., SL UE 102′, or base station 110) for positioning measurements, via the transceivers 610, 612, such as a PLI report, which may include the error message. The error message may indicate that the UE was unable to obtain the at least one positioning measurement within the configured time window. The error message may include an indication of the timing of the error within the configured time window, e.g., such as an indication that the UE attempted to obtain the positioning measurements but was unable to obtain the positioning measurements until an end of the configured time window, or was unable to obtain the positioning measurements at a start of the configured time window, or may indicate a start and an end of a measured window during which one or more positioning measurements were obtained within the configured time window. The error message may include an indication of a cause of the error, such as an indication that the UE attempted to obtain the positioning measurements but did not receive a PRS processing window or if the PRS processing window was obtained, the error message may indicate when the PRS priority is lower than downlink signals or channels within the PRS processing window.

The methodologies described herein may be implemented by various means depending upon the application. For example, these methodologies may be implemented in hardware, firmware, software, or any combination thereof. For a hardware implementation, the one or more processors 602 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 620 or memory 604 that is connected to and executed by the one or more processors 602. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 608 on a non-transitory computer readable medium, such as medium 620 and/or memory 604. Examples include computer readable media encoded with a data structure and computer readable media encoded with a computer program code 608. For example, the non-transitory computer readable medium including program code 608 stored thereon may include program code 608 to support positioning of a UE using a configured time window and reporting a configured time window error in a manner consistent with disclosed embodiments. Non-transitory computer readable medium 620 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 608 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 620, instructions and/or data may be provided as signals on transmission media included in a communication apparatus. For example, a communication apparatus may include a wireless transceiver 610 having signals indicative of instructions and data. The instructions and data are configured to cause one or more processors to implement the functions outlined in the claims. That is, the communication apparatus includes transmission media with signals indicative of information to perform disclosed functions.

Memory 604 may represent any data storage mechanism. Memory 604 may include, for example, a primary memory and/or a secondary memory. Primary memory may include, for example, a random access memory, read only memory, etc. While illustrated in this example as being separate from one or more processors 602, it should be understood that all or part of a primary memory may be provided within or otherwise co-located/coupled with the one or more processors 602. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 620. As such, in certain example implementations, the methods and/or apparatuses presented herein may take the form in whole or part of a computer readable medium 620 that may include computer implementable program code 608 stored thereon, which if executed by one or more processors 602 may be operatively enabled to perform all or portions of the example operations as described herein. Computer readable medium 620 may be a part of memory 604.

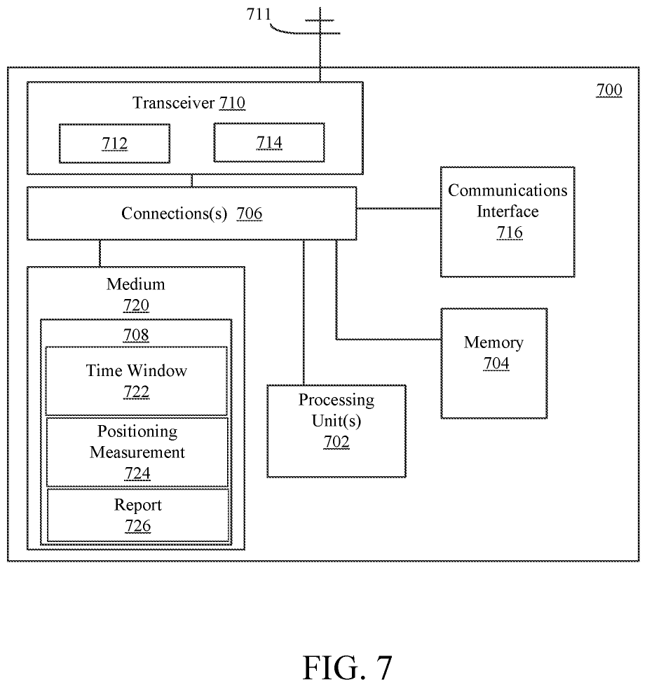

FIG. 7 shows a schematic block diagram illustrating certain exemplary features of a base station 700, e.g., which may be eNB or gNB 110, that is configured for supporting positioning using a configured time window and reporting a configured time window error, e.g., as discussed herein. The base station 700 may perform the message flow 500 illustrated in FIG. 5 and the procedure 900 illustrated in FIG. 9 along with other algorithms discussed herein.

Base station 700 may, for example, include one or more processors 702, memory 704, an external interface, which may include a wireless transceiver 710 (e.g., wireless network interface) and a communications interface 716 (e.g., wireline or wireless network interface to other base stations and/or entities in the core network such as the LMF 120 or SLP 129 via the AMF 115 or UPF 126 for communication with an external client 130), which may be operatively coupled with one or more connections 706 (e.g., buses, lines, fibers, links, etc.) to non-transitory computer readable medium 720 and memory 704. The base station 700 may further include additional items, which are not shown, such as a user interface that may include e.g., a display, a keypad or other input device, such as virtual keypad on the display, through which a user may interface with the base station. In certain example implementations, all or part of base station 700 may take the form of a chipset, and/or the like. Transceiver 710 may, for example, include a transmitter 712 enabled to transmit one or more signals over one or more types of wireless communication networks and a receiver 714 to receive one or more signals transmitted over the one or more types of wireless communication networks. The communications interface 716 may be a wired or wireless interface capable of connecting to other base stations in the RAN or network entities, such as a location server, e.g., LMF 120 or SLP 129, or LSS 117 shown in FIG. 1 or 2.

In some embodiments, base station 700 may include antenna 711, which may be internal or external. Antenna 711 may be used to transmit and/or receive signals processed by transceiver 710. In some embodiments, antenna 711 may be coupled to transceiver 710. In some embodiments, measurements of signals received (transmitted) by base station 700 may be performed at the point of connection of the antenna 711 and transceiver 710. For example, the measurement point of reference for received (transmitted) RF signal measurements may be an input (output) terminal of the receiver 714 (transmitter 712) and an output (input) terminal of the antenna 711. In a base station 700 with multiple antennas 711 or antenna arrays, the antenna connector may be viewed as a virtual point representing the aggregate output (input) of multiple antennas. In some embodiments, base station 700 may measure received signals including signal strength and TOA measurements and the raw measurements may be processed by the one or more processors 702, such as AOA, RSRP, Rx-TX, TOA, etc., of UL SRS signals from the UE 102.

The one or more processors 702 may be implemented using a combination of hardware, firmware, and software. For example, the one or more processors 702 may be configured to perform the functions discussed herein by implementing one or more instructions or program code 708 on a non-transitory computer readable medium, such as medium 720 and/or memory 704. In some embodiments, the one or more processors 702 may represent one or more circuits configurable to perform at least a portion of a data signal computing procedure or process related to the operation of base station 700.

The medium 720 and/or memory 704 may store instructions or program code 708 that contain executable code or software instructions that when executed by the one or more processors 702 cause the one or more processors 702 to operate as a special purpose computer programmed to perform the techniques disclosed herein. As illustrated in base station 700, the medium 720 and/or memory 704 may include one or more components or modules that may be implemented by the one or more processors 702 to perform the methodologies described herein. While the components or modules are illustrated as software in medium 720 that is executable by the one or more processors 702, it should be understood that the components or modules may be stored in memory 704 or may be dedicated hardware either in the one or more processors 702 or off the processors. A number of software modules and data tables may reside in the medium 720 and/or memory 704 and be utilized by the one or more processors 702 in order to manage both communications and the functionality described herein. It should be appreciated that the organization of the contents of the medium 720 and/or memory 704 as shown in base station 700 is merely exemplary, and as such the functionality of the modules and/or data structures may be combined, separated, and/or be structured in different ways depending upon the implementation of the base station 700.

The medium 720 and/or memory 704 may include a time window module 722 that when implemented by the one or more processors 702 configures the one or more processors 702 to receive from a location server, e.g., via the communications interface 716, the configured time window to obtain positioning measurements for the UE location measurements. The configured time window, for example, may be, e.g., a measurement time window. The one or more processors 702 may be further configured to determine a PRS processing window, e.g., based on the measurement time window, and send the PRS processing window to the UE via the transceiver 710.

The medium 720 and/or memory 704 may include a positioning measurements module 724 that when implemented by the one or more processors 702 configures the one or more processors 702 to obtain positioning measurements, e.g., via the transceiver 710, for the UE based on positioning signals from the UE 102 within the configured time window. The positioning measurements, for example, may include a measurement of uplink signals from the UE comprising at least one AOA, RSRP, Rx-Tx, Time of Arrival (TOA), etc.

The medium 720 and/or memory 704 may include a report module 726 that when implemented by the one or more processors 702 configures the one or more processors 702 to send a report to a positioning entity (e.g., the target UE or location server) for the positioning measurements, via the transceiver 710 or communications interface 716 such as a PLI report, which may include an error message. The error message may indicate that the base station was unable to obtain the at least one positioning measurement within the configured time window. The error message may include an indication of the timing of the error within the configured time window, e.g., such as an indication that the base station attempted to obtain the positioning measurements but was unable to obtain the positioning measurements until an end of the configured time window, or was unable to obtain the positioning measurements at a start of the configured time window, or may indicate a start and an end of a measured window during which one or more positioning measurements were obtained within the configured time window.

The methodologies described herein may be implemented by various means depending upon the application. For example, these methodologies may be implemented in hardware, firmware, software, or any combination thereof. For a hardware implementation, the one or more processors 702 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 720 or memory 704 that is connected to and executed by the one or more processors 702. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 708 on a non-transitory computer readable medium, such as medium 720 and/or memory 704. Examples include computer readable media encoded with a data structure and computer readable media encoded with a computer program code 708. For example, the non-transitory computer readable medium including program code 708 stored thereon may include program code 708 to support positioning of the UE using a configured time window and reporting a configured time window error in a manner consistent with disclosed embodiments.

Non-transitory computer readable medium 720 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 708 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 720, instructions and/or data may be provided as signals on transmission media included in a communication apparatus. For example, a communication apparatus may include a transceiver 710 having signals indicative of instructions and data. The instructions and data are configured to cause one or more processors to implement the functions outlined in the claims. That is, the communication apparatus includes transmission media with signals indicative of information to perform disclosed functions.

Memory 704 may represent any data storage mechanism. Memory 704 may include, for example, a primary memory and/or a secondary memory. Primary memory may include, for example, a random access memory, read only memory, etc. While illustrated in this example as being separate from one or more processors 702, it should be understood that all or part of a primary memory may be provided within or otherwise co-located/coupled with the one or more processors 702. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 720. As such, in certain example implementations, the methods and/or apparatuses presented herein may take the form in whole or part of a computer readable medium 720 that may include computer implementable program code 708 stored thereon, which if executed by one or more processors 702 may be operatively enabled to perform all or portions of the example operations as described herein. Computer readable medium 720 may be a part of memory 704.

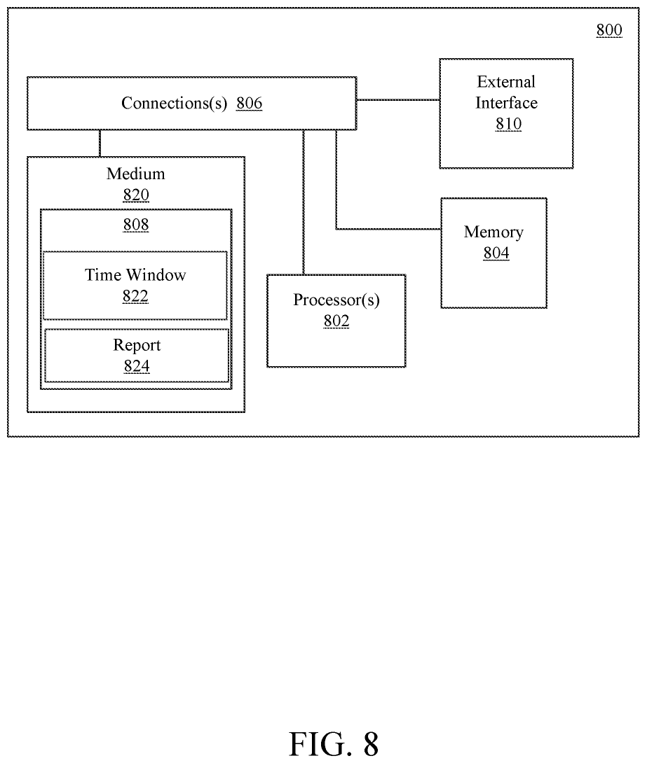

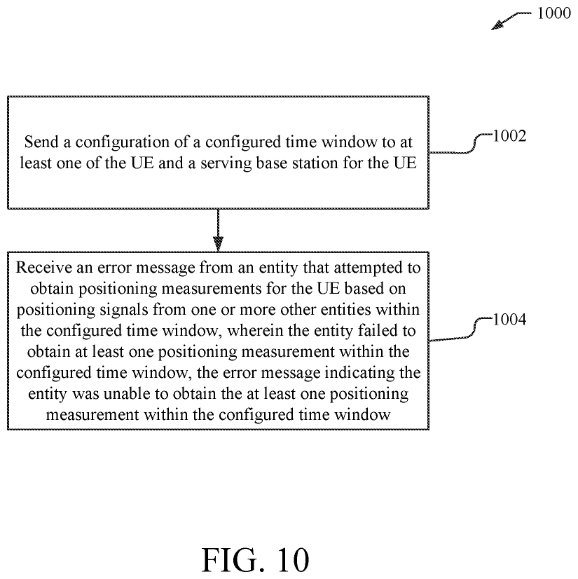

FIG. 8 shows a schematic block diagram illustrating certain exemplary features of a location server 800 in a wireless network that is configured to support positioning of a UE using a configured time window and a configured time window error report, e.g., as discussed herein. The location server 800 may be an LMF 120, an SLP 129, gNB 110, LSS 117 (or LMC) in the NG-RAN 135, as shown in FIGS. 1 and 2. The location server 800 may be configured to perform the message flow 500 illustrated in FIG. 5 and the procedure 1000 illustrated in FIG. 10 along with other algorithms discussed herein.

The location server 800 may, for example, include one or more processors 802, memory 804, an external interface 810 (e.g., wireline or wireless network interface to base stations, UEs, and/or entities in the core network), which may be operatively coupled with one or more connections 806 (e.g., buses, lines, fibers, links, etc.) to non-transitory computer readable medium 820 and memory 804. In certain example implementations, all or part of location server 800 may take the form of a chipset, and/or the like. Depending on the implementation, the location server 800 may include additional components not illustrated herein.

The one or more processors 802 may be implemented using a combination of hardware, firmware, and software. For example, the one or more processors 802 may be configured to perform the functions discussed herein by implementing one or more instructions or program code 808 on a non-transitory computer readable medium, such as medium 820 and/or memory 804. In some embodiments, the one or more processors 802 may represent one or more circuits configurable to perform at least a portion of a data signal computing procedure or process related to the operation of location server 800.

The medium 820 and/or memory 804 may store instructions or program code 808 that contain executable code or software instructions that when executed by the one or more processors 802 cause the one or more processors 802 to operate as a special purpose computer programmed to perform the techniques disclosed herein. As illustrated in location server 800, the medium 820 and/or memory 804 may include one or more components or modules that may be implemented by the one or more processors 802 to perform the methodologies described herein. While the components or modules are illustrated as software in medium 820 that is executable by the one or more processors 802, it should be understood that the components or modules may be stored in memory 804 or may be dedicated hardware either in the one or more processors 802 or off the processors.

A number of software modules and data tables may reside in the medium 820 and/or memory 804 and be utilized by the one or more processors 802 in order to manage both communications and the functionality described herein. It should be appreciated that the organization of the contents of the medium 820 and/or memory 804 as shown in location server 800 is merely exemplary, and as such the functionality of the modules and/or data structures may be combined, separated, and/or be structured in different ways depending upon the implementation of the location server 800.

The medium 820 and/or memory 804 may include a time window module 822 that when implemented by the one or more processors 802 configures the one or more processors 802 to send to a base station and/or UE, e.g., via the external interface 810, a configured time window, such as a measurement time window, to obtain positioning measurements for the UE location measurements. A serving base station for the UE may generate a PRS processing window based on the configured time window and configured the UE with the PRS processing window.

The medium 820 and/or memory 804 may include a report module 824 that when implemented by the one or more processors 802 configures the one or more processors 802 to receive a report from a positioning entity (e.g., UE 102, SL UE 102′, or base station 110) for the positioning measurements, via the external interface 810 such as a PLI report, which may include an error message. The error message may indicate that the positioning entity was unable to obtain the at least one positioning measurement within the configured time window. The error message may include an indication of the timing of the error within the configured time window, e.g., such as an indication that the positioning entity attempted to obtain the positioning measurements but was unable to obtain the positioning measurements until an end of the configured time window, or was unable to obtain the positioning measurements at a start of the configured time window, or may indicate a start and an end of a measured window during which one or more positioning measurements were obtained within the configured time window. The error message may include an indication of a cause of the error, such as an indication that the positioning entity attempted to obtain the positioning measurements but did not receive a PRS processing window or if the PRS processing window was obtained, the error message may indicate when the PRS priority is lower than downlink signals or channels within the PRS processing window.

The methodologies described herein may be implemented by various means depending upon the application. For example, these methodologies may be implemented in hardware, firmware, software, or any combination thereof. For a hardware implementation, the one or more processors 802 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 820 or memory 804 that is connected to and executed by the one or more processors 802. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 808 on a non-transitory computer readable medium, such as medium 820 and/or memory 804. Examples include computer readable media encoded with a data structure and computer readable media encoded with a computer program code 808. For example, the non-transitory computer readable medium including program code 808 stored thereon may include program code 808 to support positioning using a configured time window and a configured time window error report in a manner consistent with disclosed embodiments. Non-transitory computer readable medium 820 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 808 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 820, instructions and/or data may be provided as signals on transmission media included in a communication apparatus. For example, a communication apparatus may include an external interface 810 having signals indicative of instructions and data. The instructions and data are configured to cause one or more processors to implement the functions outlined in the claims. That is, the communication apparatus includes transmission media with signals indicative of information to perform disclosed functions.

Memory 804 may represent any data storage mechanism. Memory 804 may include, for example, a primary memory and/or a secondary memory. Primary memory may include, for example, a random access memory, read only memory, etc. While illustrated in this example as being separate from one or more processors 802, it should be understood that all or part of a primary memory may be provided within or otherwise co-located/coupled with the one or more processors 802. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 820. As such, in certain example implementations, the methods and/or apparatuses presented herein may take the form in whole or part of a computer readable medium 820 that may include computer implementable program code 808 stored thereon, which if executed by one or more processors 802 may be operatively enabled to perform all or portions of the example operations as described herein. Computer readable medium 820 may be a part of memory 804.

FIG. 9 shows a flowchart for an exemplary process 900 for locating a user equipment (e.g. a UE 102) within a configured time window, performed by an entity such as the measuring entities, UE 102, sidelink UE 102′, or base station 110, as illustrated in FIGS. 1, 2, 5, 6, and 7, in a manner consistent with disclosed implementations.

At block 902, the entity receives the configured time window to obtain positioning measurements for the UE location measurements for the UE from one or more other entities, e.g., as discussed at stages 7, 8, or 10 of FIG. 5. The configured time window, for example, may be at least one of a measurement time window, a positioning reference signal (PRS) processing window, or a combination thereof. A means for receiving the configured time window to obtain positioning measurements for the UE may include, e.g., one or more of the transceivers 610, 612 and one or more processors 602 with dedicated hardware or implementing executable code or software instructions in memory 604 and/or medium 620 in UE 600, such as the time window module 622, shown in FIG. 6 or the communications interface 716 and one or more processors 702 with dedicated hardware or implementing executable code or software instructions in memory 704 and/or medium 720 in base station 700, such as the time window module 722, shown in FIG. 7.

At block 904, the entity attempts to obtain the positioning measurements for the UE based on positioning signals from one or more other entities within the configured time window, wherein the entity fails to obtain at least one positioning measurement within the configured time window, e.g., as discussed at stages 11a or 11b of FIG. 5. The one or more other entities, for example, may include at least one of the UE 102, a serving base station 110, neighboring base station 110, or a sidelink UE 102′. In one implementation, the positioning measurements may include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer. A means for attempting to obtain the positioning measurements for the UE based on positioning signals from one or more other entities within the configured time window, wherein the entity failed to obtain at least one positioning measurement within the configured time window may include, e.g., one or more of the transceivers 610, 612 and one or more processors 602 with dedicated hardware or implementing executable code or software instructions in memory 604 and/or medium 620 in UE 600, such as the positioning measurements module 624, shown in FIG. 6 or the transceiver 710 and one or more processors 702 with dedicated hardware or implementing executable code or software instructions in memory 704 and/or medium 720 in base station 700, such as the positioning measurements module 724, shown in FIG. 7.

At block 906, the entity sends an error message to a positioning entity indicating unable to obtain the at least one positioning measurement within the configured time window, e.g., as discussed at stages 12 or 13 of FIG. 5. The positioning entity may be a location server or the UE. The error message may be included in a provide location information message. A means for sending an error message to a positioning entity indicating unable to obtain the at least one positioning measurement within the configured time window may include, e.g., one or more of the transceivers 610, 612 and one or more processors 602 with dedicated hardware or implementing executable code or software instructions in memory 604 and/or medium 620 in UE 600, such as the report module 626, shown in FIG. 6 or the transceiver 710 and one or more processors 702 with dedicated hardware or implementing executable code or software instructions in memory 704 and/or medium 720 in base station 700, such as the report module 726, shown in FIG. 7.

In one implementation, the error message may indicate the entity attempted to obtain the positioning measurements but was unable to obtain the positioning measurements until an end of the configured time window, e.g., as discussed in stages 12 or 13 of FIG. 5 and with reference to FIG. 4.

In one implementation, the error message may indicate the entity attempted to obtain the positioning measurements but was unable to obtain the positioning measurements at a start of the configured time window, e.g., as discussed in stages 12 or 13 of FIG. 5 and with reference to FIG. 4.

In one implementation, the configured time window may be a measurement time window, and the error message may indicate the entity attempted to obtain the positioning measurements but did not receive a positioning reference signal (PRS) processing window, e.g., as discussed in stage 12 of FIG. 5 and with reference to FIG. 4.

In one implementation, the configured time window may be a positioning reference signal (PRS) processing window, and the error message may indicate the entity attempted to obtain the positioning measurements but PRS priority is lower than downlink signals or channels within the PRS processing window, e.g., as discussed in stage 12 of FIG. 5 and with reference to FIG. 4.

In one implementation, the error message may indicate a start and an end of a measured window during which one or more positioning measurements were obtained within the configured time window, e.g., as discussed in stages 12 or 13 of FIG. 5 and with reference to FIG. 4.

FIG. 10 shows a flowchart for an exemplary process 1000 for locating a user equipment (e.g. a UE 102) within a configured time window, performed by a positioning entity such as a location server, such as LMF 120, SLP 129, LSS 117, or LMC in an NG-RAN 135 as illustrated in FIGS. 1, 2, 5, 6, and 8, in a manner consistent with disclosed implementations.

At block 1002, the positioning entity may send a configuration of a configured time window to at least one of the UE and a serving base station for the UE, e.g., as discussed at stages 7 and 10 of FIG. FIG. 5. The configured time window may be at least one of a measurement time window, a positioning reference signal (PRS) processing window, or a combination thereof. A means for sending a configuration of a configured time window to at least one of the UE and a serving base station for the UE may include, e.g., the external interface 810 and one or more processors 802 with dedicated hardware or implementing executable code or software instructions in memory 804 and/or medium 820 in the location server 800, such as the time window module 822, shown in FIG. 8.

At block 1004, the positioning entity may receive an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window, e.g., as discussed at stages 12 and 13 of FIG. 5. The entity, for example, may be the UE 102, a base station 110, or the sidelink UE 102′. The one or more other entities may include at least one of the UE 102, a serving base station 110, neighboring base station 110, or the sidelink UE 102′. In one implementation, the error message may be included in a provide location information message. The positioning measurements, for example, may include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer. A means for receiving an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window may include, e.g., the external interface 810 and one or more processors 802 with dedicated hardware or implementing executable code or software instructions in memory 804 and/or medium 820 in the location server 800, such as the report module 824, shown in FIG. 8.

In one implementation, the positioning entity may send the measurement time window to the entity before the entity attempts to obtain the positioning measurements, e.g., as discussed at stages 7 and 10 of FIG. FIG. 5. A means for sending the measurement time window to the entity before the entity attempts to obtain the positioning measurements may include, e.g., the external interface 810 and one or more processors 802 with dedicated hardware or implementing executable code or software instructions in memory 804 and/or medium 820 in the location server 800, such as the time window module 822, shown in FIG. 8.

In one implementation, the error message may indicate the entity attempted to obtain the positioning measurements but was unable to obtain the positioning measurements until an end of the configured time window, e.g., as discussed in stages 12 or 13 of FIG. 5 and with reference to FIG. 4.

In one implementation, the error message may indicate the entity attempted to obtain the positioning measurements but was unable to obtain the positioning measurements at a start of the configured time window, e.g., as discussed in stages 12 or 13 of FIG. 5 and with reference to FIG. 4.

In one implementation, the configured time window may be a measurement time window, and the error message may indicate the entity attempted to obtain the positioning measurements but did not receive a positioning reference signal (PRS) processing window, e.g., as discussed in stage 12 of FIG. 5 and with reference to FIG. 4.

In one implementation, the configured time window may be a positioning reference signal (PRS) processing window, and the error message may indicate the entity attempted to obtain the positioning measurements but PRS priority is lower than downlink signals or channels within the PRS processing window, e.g., as discussed in stage 12 of FIG. 5 and with reference to FIG. 4.

In one implementation, the error message may indicate a start and an end of a measured window during which one or more positioning measurements were obtained within the configured time window, e.g., as discussed in stages 12 or 13 of FIG. 5 and with reference to FIG. 4.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “of” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

In view of this description embodiments may include different combinations of features. Implementation examples are described in the following numbered clauses:

Clause 1. A method at an entity for locating a UE within a configured time window, comprising: receiving the configured time window to obtain positioning measurements for the UE; attempting to obtain the positioning measurements for the UE based on positioning signals from one or more other entities within the configured time window, wherein the entity failed to obtain at least one positioning measurement within the configured time window; and sending an error message to a positioning entity indicating unable to obtain the at least one positioning measurement within the configured time window.

Clause 2. The method of clause 1, wherein the entity is the UE, a base station, or a sidelink UE.

Clause 3. The method of any of clauses 1-2, wherein the one or more other entities include at least one of the UE, a serving base station, neighboring base station, or a sidelink UE.

Clause 4. The method of any of clauses 1-3, wherein the positioning entity is one of a location server or the UE.

Clause 5. The method of any of clauses 1-4, wherein the configured time window is at least one of a measurement time window, a positioning reference signal (PRS) processing window, or a combination thereof.

Clause 6. The method of any of clauses 1-5, wherein the error message is included in a provide location information message.

Clause 7. The method of any of clauses 1-6, wherein the error message indicates the entity attempted to obtain the positioning measurements but was unable to obtain the positioning measurements until an end of the configured time window.

Clause 8. The method of any of clauses 1-7, wherein the error message indicates the entity attempted to obtain the positioning measurements but was unable to obtain the positioning measurements at a start of the configured time window.

Clause 9. The method of any of clauses 1-8, wherein the configured time window comprises at least a measurement time window, and the error message indicates the entity attempted to obtain the positioning measurements but did not receive a positioning reference signal (PRS) processing window.

Clause 10. The method of any of clauses 1-8, wherein the configured time window comprises a positioning reference signal (PRS) processing window, and the error message indicates the entity attempted to obtain the positioning measurements but PRS priority is lower than downlink signals or channels within the PRS processing window.

Clause 11. The method of any of clauses 1-10, wherein the error message indicates a start and an end of a measured window during which one or more positioning measurements were obtained within the configured time window.

Clause 12. The method of any of clauses 1-11, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 13. An entity in a wireless network configured for locating a UE within a configured time window, comprising: an external interface configured to communicate with other entities in the wireless network; at least one memory; and at least one processor coupled to the external interface and the at least one memory and configured to: receive the configured time window to obtain positioning measurements for the UE; attempt to obtain the positioning measurements for the UE based on positioning signals from one or more other entities within the configured time window, wherein the entity failed to obtain at least one positioning measurement within the configured time window; and send an error message to a positioning entity indicating unable to obtain the at least one positioning measurement within the configured time window.

Clause 14. The entity of clause 13, wherein the entity is the UE, a base station, or a sidelink UE.

Clause 15. The entity of any of clauses 13-14, wherein the one or more other entities include at least one of the UE, a serving base station, neighboring base station, or a sidelink UE.

Clause 16. The entity of any of clauses 13-15, wherein the positioning entity is one of a location server or the UE.

Clause 17. The entity of any of clauses 13-16, wherein the configured time window is at least one of a measurement time window, a positioning reference signal (PRS) processing window, or a combination thereof.

Clause 18. The entity of any of clauses 13-17, wherein the error message is included in a provide location information message.

Clause 19. The entity of any of clauses 13-18, wherein the error message indicates the entity attempted to obtain the positioning measurements but was unable to obtain the positioning measurements until an end of the configured time window.

Clause 20. The entity of any of clauses 13-19, wherein the error message indicates the entity attempted to obtain the positioning measurements but was unable to obtain the positioning measurements at a start of the configured time window.

Clause 21. The entity of any of clauses 13-20, wherein the configured time window comprises at least a measurement time window, and the error message indicates the entity attempted to obtain the positioning measurements but did not receive a positioning reference signal (PRS) processing window.

Clause 22. The entity of any of clauses 13-20, wherein the configured time window comprises a positioning reference signal (PRS) processing window, and the error message indicates the entity attempted to obtain the positioning measurements but PRS priority is lower than downlink signals or channels within the PRS processing window.

Clause 23. The entity of any of clauses 13-22, wherein the error message indicates a start and an end of a measured window during which one or more positioning measurements were obtained within the configured time window.

Clause 24. The entity of any of clauses 13-23, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 25. An entity in a wireless network configured for locating a UE within a configured time window, comprising: means for receiving the configured time window to obtain positioning measurements for the UE; means for attempting to obtain the positioning measurements for the UE based on positioning signals from one or more other entities within the configured time window, wherein the entity failed to obtain at least one positioning measurement within the configured time window; and means for sending an error message to a positioning entity indicating unable to obtain the at least one positioning measurement within the configured time window.

Clause 26. The entity of clause 25, wherein the entity is the UE, a base station, or a sidelink UE.

Clause 27. The entity of any of clauses 25-26, wherein the one or more other entities include at least one of the UE, a serving base station, neighboring base station, or a sidelink UE.

Clause 28. The entity of any of clauses 25-27, wherein the positioning entity is one of a location server or the UE.

Clause 29. The entity of any of clauses 25-28, wherein the configured time window is at least one of a measurement time window, a positioning reference signal (PRS) processing window, or a combination thereof.

Clause 30. The entity of any of clauses 25-29, wherein the error message is included in a provide location information message.

Clause 31. The entity of any of clauses 25-30, wherein the error message indicates the entity attempted to obtain the positioning measurements but was unable to obtain the positioning measurements until an end of the configured time window.

Clause 32. The entity of any of clauses 25-31, wherein the error message indicates the entity attempted to obtain the positioning measurements but was unable to obtain the positioning measurements at a start of the configured time window.

Clause 33. The entity of any of clauses 25-32, wherein the configured time window comprises at least a measurement time window, and the error message indicates the entity attempted to obtain the positioning measurements but did not receive a positioning reference signal (PRS) processing window.

Clause 34. The entity of any of clauses 25-32, wherein the configured time window comprises a positioning reference signal (PRS) processing window, and the error message indicates the entity attempted to obtain the positioning measurements but PRS priority is lower than downlink signals or channels within the PRS processing window.

Clause 35. The entity of any of clauses 25-34, wherein the error message indicates a start and an end of a measured window during which one or more positioning measurements were obtained within the configured time window.

Clause 36. The entity of any of clauses 25-35, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 37. A non-transitory storage medium including program code stored thereon, the program code is operable to configure at least one processor in an entity in a wireless network configured for locating a UE within a configured time window, the program code comprising instructions to: receive the configured time window to obtain positioning measurements for the UE; attempt to obtain the positioning measurements for the UE based on positioning signals from one or more other entities within the configured time window, wherein the entity failed to obtain at least one positioning measurement within the configured time window; and send an error message to a positioning entity indicating unable to obtain the at least one positioning measurement within the configured time window.

Clause 38. The non-transitory storage medium of clause 37, wherein the entity is the UE, a base station, or a sidelink UE.

Clause 39. The non-transitory storage medium of any of clauses 37-38, wherein the one or more other entities include at least one of the UE, a serving base station, neighboring base station, or a sidelink UE.

Clause 40. The non-transitory storage medium of any of clauses 37-39, wherein the positioning entity is one of a location server or the UE.

Clause 41. The non-transitory storage medium of any of clauses 37-40, wherein the configured time window is at least one of a measurement time window, a positioning reference signal (PRS) processing window, or a combination thereof.

Clause 42. The non-transitory storage medium of any of clauses 37-41, wherein the error message is included in a provide location information message.

Clause 43. The non-transitory storage medium of any of clauses 37-42, wherein the error message indicates the entity attempted to obtain the positioning measurements but was unable to obtain the positioning measurements until an end of the configured time window.

Clause 44. The non-transitory storage medium of any of clauses 37-43, wherein the error message indicates the entity attempted to obtain the positioning measurements but was unable to obtain the positioning measurements at a start of the configured time window.

Clause 45. The non-transitory storage medium of any of clauses 37-44, wherein the configured time window comprises at least a measurement time window, and the error message indicates the entity attempted to obtain the positioning measurements but did not receive a positioning reference signal (PRS) processing window.

Clause 46. The non-transitory storage medium of any of clauses 37-44, wherein the configured time window comprises a positioning reference signal (PRS) processing window, and the error message indicates the entity attempted to obtain the positioning measurements but PRS priority is lower than downlink signals or channels within the PRS processing window.

Clause 47. The non-transitory storage medium of any of clauses 37-46, wherein the error message indicates a start and an end of a measured window during which one or more positioning measurements were obtained within the configured time window.

Clause 48. The non-transitory storage medium of any of clauses 37-47, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 49. A method at a positioning entity for locating a UE within a configured time window, comprising: sending a configuration of a configured time window to at least one of the UE and a serving base station for the UE; and receiving an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

Clause 50. The method of clause 49, wherein the positioning entity is one of a location server or the UE.

Clause 51. The method of any of clauses 49-50, wherein the entity is the UE, a base station, or a sidelink UE.

Clause 52. The method of any of clauses 49-51, wherein the one or more other entities include at least one of the UE, a serving base station, neighboring base station, or a sidelink UE.

Clause 53. The method of any of clauses 49-52, wherein the configured time window is at least one of a measurement time window, a positioning reference signal (PRS) processing window, or a combination thereof.

Clause 54. The method of any of clauses 49-53, further comprising sending the measurement time window to the entity before the entity attempts to obtain the positioning measurements.

Clause 55. The method of any of clauses 49-54, wherein the error message is included in a provide location information message.

Clause 56. The method of any of clauses 49-55, wherein the error message indicates the entity attempted to obtain the positioning measurements but was unable to obtain the positioning measurements until an end of the configured time window.

Clause 57. The method of any of clauses 49-56, wherein the error message indicates the entity attempted to obtain the positioning measurements but was unable to obtain the positioning measurements at a start of the configured time window.

Clause 58. The method of any of clauses 49-57, wherein the configured time window comprises at least a measurement time window, and the error message indicates the entity attempted to obtain the positioning measurements but did not receive a positioning reference signal (PRS) processing window.

Clause 59. The method of any of clauses 49-58, wherein the configured time window comprises a positioning reference signal (PRS) processing window, and the error message indicates the entity attempted to obtain the positioning measurements but PRS priority is lower than downlink signals or channels within the PRS processing window.

Clause 60. The method of any of clauses 49-59, wherein the error message indicates a start and an end of a measured window during which one or more positioning measurements were obtained within the configured time window.

Clause 61. The method of any of clauses 49-60, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 62. A positioning entity in a wireless network configured for locating a UE within a configured time window, comprising: an external interface configured to communicate with other entities in the wireless network; at least one memory; and at least one processor coupled to the external interface and the at least one memory and configured to: send a configuration of a configured time window to at least one of the UE and a serving base station for the UE; and receive an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

Clause 63. The positioning entity of clause 62, wherein the positioning entity is one of a location server or the UE.

Clause 64. The positioning entity of any of clauses 62-63, wherein the entity is the UE, a base station, or a sidelink UE.

Clause 65. The positioning entity of any of clauses 62-64, wherein the one or more other entities include at least one of the UE, a serving base station, neighboring base station, or a sidelink UE.

Clause 66. The positioning entity of any of clauses 62-65, wherein the configured time window is at least one of a measurement time window, a positioning reference signal (PRS) processing window, or a combination thereof.

Clause 67. The positioning entity of any of clauses 62-66, wherein the at least one process or further configured to send the measurement time window to the entity before the entity attempts to obtain the positioning measurements.

Clause 68. The positioning entity of any of clauses 62-67, wherein the error message is included in a provide location information message.

Clause 69. The positioning entity of any of clauses 62-68, wherein the error message indicates the entity attempted to obtain the positioning measurements but was unable to obtain the positioning measurements until an end of the configured time window.

Clause 70. The positioning entity of any of clauses 62-69, wherein the error message indicates the entity attempted to obtain the positioning measurements but was unable to obtain the positioning measurements at a start of the configured time window.

Clause 71. The positioning entity of any of clauses 62-70, wherein the configured time window comprises at least a measurement time window, and the error message indicates the entity attempted to obtain the positioning measurements but did not receive a positioning reference signal (PRS) processing window.

Clause 72. The positioning entity of any of clauses 62-70, wherein the configured time window comprises a positioning reference signal (PRS) processing window, and the error message indicates the entity attempted to obtain the positioning measurements but PRS priority is lower than downlink signals or channels within the PRS processing window.

Clause 73. The positioning entity of any of clauses 62-72, wherein the error message indicates a start and an end of a measured window during which one or more positioning measurements were obtained within the configured time window.

Clause 74. The positioning entity of any of clauses 62-73, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 75. A positioning entity in a wireless network configured for locating a UE within a configured time window, comprising: means for sending a configuration of a configured time window to at least one of the UE and a serving base station for the UE; and means for receiving an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

Clause 76. The positioning entity of clause 75, wherein the positioning entity is one of a location server or the UE.

Clause 77. The positioning entity of any of clauses 75-76, wherein the entity is the UE, a base station, or a sidelink UE.

Clause 78. The positioning entity of any of clauses 75-77, wherein the one or more other entities include at least one of the UE, a serving base station, neighboring base station, or a sidelink UE.

Clause 79. The positioning entity of any of clauses 75-78, wherein the configured time window is at least one of a measurement time window, a positioning reference signal (PRS) processing window, or a combination thereof.

Clause 80. The positioning entity of any of clauses 75-79, further comprising means for sending the measurement time window to the entity before the entity attempts to obtain the positioning measurements.

Clause 81. The positioning entity of any of clauses 75-80, wherein the error message is included in a provide location information message.

Clause 82. The positioning entity of any of clauses 75-81, wherein the error message indicates the entity attempted to obtain the positioning measurements but was unable to obtain the positioning measurements until an end of the configured time window.

Clause 83. The positioning entity of any of clauses 75-82, wherein the error message indicates the entity attempted to obtain the positioning measurements but was unable to obtain the positioning measurements at a start of the configured time window.

Clause 84. The positioning entity of any of clauses 75-83, wherein the configured time window comprises at least a measurement time window, and the error message indicates the entity attempted to obtain the positioning measurements but did not receive a positioning reference signal (PRS) processing window.

Clause 85. The positioning entity of any of clauses 75-83, wherein the configured time window comprises a positioning reference signal (PRS) processing window, and the error message indicates the entity attempted to obtain the positioning measurements but PRS priority is lower than downlink signals or channels within the PRS processing window.

Clause 86. The positioning entity of any of clauses 75-85, wherein the error message indicates a start and an end of a measured window during which one or more positioning measurements were obtained within the configured time window.

Clause 87. The positioning entity of any of clauses 75-86, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

Clause 88. A non-transitory storage medium including program code stored thereon, the program code is operable to configure at least one processor in a positioning entity in a wireless network configured for locating a UE within a configured time window, the program code comprising instructions to: send a configuration of a configured time window to at least one of the UE and a serving base station for the UE; and receive an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

Clause 89. The non-transitory storage medium of clause 88, wherein the positioning entity is one of a location server or the UE.

Clause 90. The non-transitory storage medium of any of clauses 88-89, wherein the entity is the UE, a base station, or a sidelink UE.

Clause 91. The non-transitory storage medium of any of clauses 88-90, wherein the one or more other entities include at least one of the UE, a serving base station, neighboring base station, or a sidelink UE.

Clause 92. The non-transitory storage medium of any of clauses 88-91, wherein the configured time window is at least one of a measurement time window, a positioning reference signal (PRS) processing window, or a combination thereof.

Clause 93. The non-transitory storage medium of any of clauses 88-92, wherein the program code further comprises instructions to send the measurement time window to the entity before the entity attempts to obtain the positioning measurements.

Clause 94. The non-transitory storage medium of any of clauses 88-93, wherein the error message is included in a provide location information message.

Clause 95. The non-transitory storage medium of any of clauses 88-94, wherein the error message indicates the entity attempted to obtain the positioning measurements but was unable to obtain the positioning measurements until an end of the configured time window.

Clause 96. The non-transitory storage medium of any of clauses 88-95, wherein the error message indicates the entity attempted to obtain the positioning measurements but was unable to obtain the positioning measurements at a start of the configured time window.

Clause 97. The non-transitory storage medium of any of clauses 88-96, wherein the configured time window comprises at least a measurement time window, and the error message indicates the entity attempted to obtain the positioning measurements but did not receive a positioning reference signal (PRS) processing window.

Clause 98. The non-transitory storage medium of any of clauses 88-96, wherein the configured time window comprises a positioning reference signal (PRS) processing window, and the error message indicates the entity attempted to obtain the positioning measurements but PRS priority is lower than downlink signals or channels within the PRS processing window.

Clause 99. The non-transitory storage medium of any of clauses 88-98, wherein the error message indicates a start and an end of a measured window during which one or more positioning measurements were obtained within the configured time window.

Clause 100. The non-transitory storage medium of any of clauses 88-99, wherein the positioning measurements include at least one of a GNSS pseudorange, a GNSS codephase, a GNSS carrier phase, a WiFi measurement comprising at least one of received signal strength indication (RSSI), Angle of Arrival, Round Trip Time (RTT), a Bluetooth measurement comprising at least one of RSSI, AOA or RTT, a measurement of downlink signals from a base stations comprising at least one of Reference Signal Time Difference (RSTD), Reference Signal Received Power (RSRP), Reference Signal Received Quality (RSRQ), carrier phase measurements for positioning, Angle of Departure (AOD), AOA, time difference between reception and transmission of signals (Rx-Tx), a measurement of uplink signals from the UE comprising at least one AOA, RSRP, Rx-Tx, Time of Arrival (TOA), a measurement of sidelink signals from a sidelink UE comprising at least one of AOA, RSRP, Rx-Tx, TOA, measurement performed by a sensor comprising at least one of an inertial sensor or a barometer.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method at an entity for locating a UE within a configured time window, comprising:
receiving the configured time window to obtain positioning measurements for the UE;
attempting to obtain the positioning measurements for the UE based on positioning signals from one or more other entities within the configured time window, wherein the entity failed to obtain at least one positioning measurement within the configured time window; and
sending an error message to a positioning entity indicating unable to obtain the at least one positioning measurement within the configured time window.

2. The method of claim 1, wherein the configured time window is at least one of a measurement time window, a positioning reference signal (PRS) processing window, or a combination thereof.

3. The method of claim 1, wherein the error message indicates the entity attempted to obtain the positioning measurements but was unable to obtain the positioning measurements until an end of the configured time window.

4. The method of claim 1, wherein the error message indicates the entity attempted to obtain the positioning measurements but was unable to obtain the positioning measurements at a start of the configured time window.

5. The method of claim 1, wherein the configured time window comprises at least a measurement time window, and the error message indicates the entity attempted to obtain the positioning measurements but did not receive a positioning reference signal (PRS) processing window.

6. The method of claim 1, wherein the configured time window comprises a positioning reference signal (PRS) processing window, and the error message indicates the entity attempted to obtain the positioning measurements but PRS priority is lower than downlink signals or channels within the PRS processing window.

7. The method of claim 1, wherein the error message indicates a start and an end of a measured window during which one or more positioning measurements were obtained within the configured time window.

8. An entity in a wireless network configured for locating a UE within a configured time window, comprising:
an external interface configured to communicate with other entities in the wireless network;
at least one memory; and
at least one processor coupled to the external interface and the at least one memory and configured to:
receive the configured time window to obtain positioning measurements for the UE;
attempt to obtain the positioning measurements for the UE based on positioning signals from one or more other entities within the configured time window, wherein the entity failed to obtain at least one positioning measurement within the configured time window; and
send an error message to a positioning entity indicating unable to obtain the at least one positioning measurement within the configured time window.

9. The entity of claim 8, wherein the configured time window is at least one of a measurement time window, a positioning reference signal (PRS) processing window, or a combination thereof.

10. The entity of claim 8, wherein the error message indicates the entity attempted to obtain the positioning measurements but was unable to obtain the positioning measurements until an end of the configured time window.

11. The entity of claim 8, wherein the error message indicates the entity attempted to obtain the positioning measurements but was unable to obtain the positioning measurements at a start of the configured time window.

12. The entity of claim 8, wherein the configured time window comprises at least a measurement time window, and the error message indicates the entity attempted to obtain the positioning measurements but did not receive a positioning reference signal (PRS) processing window.

13. The entity of claim 8, wherein the configured time window comprises a positioning reference signal (PRS) processing window, and the error message indicates the entity attempted to obtain the positioning measurements but PRS priority is lower than downlink signals or channels within the PRS processing window.

14. The entity of claim 8, wherein the error message indicates a start and an end of a measured window during which one or more positioning measurements were obtained within the configured time window.

15. A method at a positioning entity for locating a UE within a configured time window, comprising:
sending a configuration of a configured time window to at least one of the UE and a serving base station for the UE; and
receiving an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

16. The method of claim 15, wherein the configured time window is at least one of a measurement time window, a positioning reference signal (PRS) processing window, or a combination thereof.

17. The method of claim 15, further comprising sending the measurement time window to the entity before the entity attempts to obtain the positioning measurements.

18. The method of claim 15, wherein the error message indicates the entity attempted to obtain the positioning measurements but was unable to obtain the positioning measurements until an end of the configured time window.

19. The method of claim 15, wherein the error message indicates the entity attempted to obtain the positioning measurements but was unable to obtain the positioning measurements at a start of the configured time window.

20. The method of claim 15, wherein the configured time window comprises at least a measurement time window, and the error message indicates the entity attempted to obtain the positioning measurements but did not receive a positioning reference signal (PRS) processing window.

21. The method of claim 15, wherein the configured time window comprises a positioning reference signal (PRS) processing window, and the error message indicates the entity attempted to obtain the positioning measurements but PRS priority is lower than downlink signals or channels within the PRS processing window.

22. The method of claim 15, wherein the error message indicates a start and an end of a measured window during which one or more positioning measurements were obtained within the configured time window.

23. A positioning entity in a wireless network configured for locating a UE within a configured time window, comprising:
an external interface configured to communicate with other entities in the wireless network;
at least one memory; and
at least one processor coupled to the external interface and the at least one memory and configured to:
send a configuration of a configured time window to at least one of the UE and a serving base station for the UE; and
receive an error message from an entity that attempted to obtain positioning measurements for the UE based on positioning signals from one or more other entities within the configured time window, wherein the entity failed to obtain at least one positioning measurement within the configured time window, the error message indicating the entity was unable to obtain the at least one positioning measurement within the configured time window.

24. The positioning entity of claim 23, wherein the configured time window is at least one of a measurement time window, a positioning reference signal (PRS) processing window, or a combination thereof.

25. The positioning entity of claim 23, wherein the at least one process or further configured to send the measurement time window to the entity before the entity attempts to obtain the positioning measurements.

26. The positioning entity of claim 23, wherein the error message indicates the entity attempted to obtain the positioning measurements but was unable to obtain the positioning measurements until an end of the configured time window.

27. The positioning entity of claim 23, wherein the error message indicates the entity attempted to obtain the positioning measurements but was unable to obtain the positioning measurements at a start of the configured time window.

28. The positioning entity of claim 23, wherein the configured time window comprises at least a measurement time window, and the error message indicates the entity attempted to obtain the positioning measurements but did not receive a positioning reference signal (PRS) processing window.

29. The positioning entity of claim 23, wherein the configured time window comprises a positioning reference signal (PRS) processing window, and the error message indicates the entity attempted to obtain the positioning measurements but PRS priority is lower than downlink signals or channels within the PRS processing window.

30. The positioning entity of claim 23, wherein the error message indicates a start and an end of a measured window during which one or more positioning measurements were obtained within the configured time window.
